(19) United States
(12) Patent Application Publication
(10) Pub. No.: US 2007/0111773 A1
(43) Pub. Date: May 17, 2007

(54) AUTOMATED TRACKING OF PLAYING CARDS

(75) Inventors: Prem Gururajan, Kitchener, ON (CA); Maulin Gandhi, Kitchener, ON (CA); Jason Jackson, Hamilton, ON (CA)

Correspondence Address: BERESKIN AND PARR, 40 KING STREET WEST, BOX 401, TORONTO, ON, M5H 3Y2, CA

(73) Assignee: TANGAM TECHNOLOGIES INC., Kitchener (CA)

(21) Appl. No.: 11/558,601

(22) Filed: Nov. 10, 2006

Related U.S. Application Data
(60) Provisional application No. 60/736,334, filed on Nov. 15, 2005.
(60) Provisional application No. 60/760,365, filed on Jan. 20, 2006.
(60) Provisional application No. 60/808,952, filed on May 30, 2006.
(60) Provisional application No. 60/809,330, filed on May 31, 2006.
(60) Provisional application No. 60/814,540, filed on Jun. 19, 2006.

(51) Int. Cl. G06F 19/00

(52) U.S. Cl. 463/11

(57) ABSTRACT

The present invention relates to a method of tracking playing cards on a game table. More specifically, it provides for detecting and recognizing partially visible playing cards within overhead images of a gaming table. Furthermore, it provides for processing a set of game data, a set of game rules, as well as a current, unresolved, game state to derive a subsequent state of the game. Finally, it provides for the detection of game events that alter tracking operations.

### RELATED APPLICATIONS

The present application claims priority from U.S. provisional patent applications No. 60/736,334, filed Nov. 15, 2005; 60/760,365, filed Jan. 20, 2006; 60/808,952, filed May 30, 2006, 60/809,330 filed May 31, 2006 and 60/814,540 filed Jun. 19, 2006.

### BACKGROUND

Casinos propose a wide variety of gambling activities to accommodate players and their preferences. Some of those activities reward strategic thinking while others are impartial, but each one of them obeys a strict set of rules that favours the casino over its clients.

The success of a casino relies partially on the efficiency and consistency with which those rules are applied by the dealer. A pair of slow dealing hands or an undeserved payout may have substantial consequences on profitability.

Another critical factor is the consistency with which those rules are respected by the player. Large sums of money travel through the casino, tempting players to bend the rules. Again, an undetected card switch or complicity between a dealer and a player may be highly detrimental to profitability.

For those reasons among others, casinos have traditionally invested tremendous efforts in monitoring gambling activities. Initially, the task was performed manually, a solution that was both expensive and inefficient. However, technological innovations have been offering advantageous alternatives that reduce costs while increasing efficiency.

One such innovation provides for monitoring games through overhead video cameras. Although its potential has never been doubted, several issues remain to be solved. For instance, performing repetitive optical recognition on consecutive images in a video stream can be processing intensive. Another challenge is that gaming objects might occasionally be partially or entirely occluded from an overhead camera view. A playing card can be occluded because of the dealer's clothing, hands or other gaming objects. Yet another issue is that cards and card hands that are moved on the table can result in blurred images. Sometimes, due to space constraints a dealer may place playing card hands such that two or more playing card hands have some overlap even though ideally there should not be any overlap between distinct playing card hands. There could be other objects on the table, such as patterns on dealer clothing that may appear somewhat similar to a playing card shape and consequently result in erroneous playing card detection (“false positives”). The disclosed invention seeks to alleviate some of these problems and challenges with respect to overhead video camera based game monitoring.

It is unreasonable to expect any gaming object positioning and identification system to be perfect. There are often scenarios where a game tracking method must analyze ambiguous gaming object data in determining the game state and game progress. For instance, an overhead video camera based recognition system can produce ambiguous or incomplete data caused by playing card occlusion, movement, false positives, dealer mistakes and overlapping of card hands. Other systems involving RFID embedded playing cards could produce similar ambiguity relating to position, movement, distinction of separate card hands, dealer mistakes false positives etc. The disclosed invention seeks to alleviate some of the challenges of ambiguous data by providing methods to improve robustness of game tracking.

One of the most important aspects of table game monitoring consists in recognizing playing cards, or at the very least, their value with respect to the game being played. Such recognition is particularly challenging when the central region of a playing card is undetectable within an overhead image of a card hand, or more generally, within that of an amalgam of overlapping objects. Current solutions for achieving such recognition bear various weaknesses, especially when confronted with those particular situations.

U.S. patent application Ser. No. 11/052,941, titled “Automated Game Monitoring”, by Tran, discloses a method of recognizing a playing card positioned on a table within an overhead image. The method consists in detecting the contour of the card, validating the card from its contour, detecting adjacent corners of the card, projecting the boundary of the card based on the adjacent corners, binarizing pixels within the boundary, and counting the number of pips to identify the value of the card. While such a method is practical for recognizing a solitary playing card, or at least one that is not significantly overlapped by other objects, it may not be applicable in cases where the corner or central region of the card is undetectable due to the presence of overlapping objects. It also does not provide a method of distinguishing between face cards.

A paper titled “Introducing Computers to Blackjack: Implementation of a Card Recognition System Using Computer Vision Techniques”, written by G. Hollinger and N. Ward, proposes the use of neural networks to distinguish face cards. The method proposes determining a central moment of individual playing cards to determine a rotation angle. This approach of determining a rotation angle is not appropriate for overlapping cards forming a card hand. They propose counting the number of pips in the central region of the card to identify number cards and to identify that a card is a face card. This approach of pip counting or analyzing the central region of a card will not be feasible when a card is significantly overlapped by another object.

Several references propose to achieve such recognition by endowing each playing card with detectable and identifiable sensors. For instance, U.S. patent application Ser. No. 18/823,051, titled “Wireless monitoring of playing cards and/or wagers in gaming”, by SOLTYS, discloses playing cards bearing a conductive material that may be wirelessly interrogated to achieve recognition in any plausible situation, regardless of visual obtrusions. One disadvantage of their implementation is that such cards are more expensive than normal playing cards. Furthermore, adhering casinos would be restricted to dealing such special playing cards instead of those of their liking.

Another important aspect of table game monitoring consists in identifying which dealer is dealing at which table. Current solutions for tracking dealers employ card readers at each table that require the dealer to swipe a card containing a magnetic strip or a barcode. A product called MP21 offered by Bally Gaming has an electronic data entry device embedded into the table and requires a dealer to “log in” at the table by entering their ID. A problem with having an electronic device, such as the MP21 data entry device, at the table is that it does not seamlessly integrate into the existing table environment. These additional devices can make the customers at the table somewhat uncomfortable or suspicious. Furthermore, these devices require wiring and computing resources located at the table or near the table. A more traditional method of tracking dealers is by using a pre-determined dealer rotation schedule. A problem with this traditional method is that it is not accurate. Dealers do not always end their shift at a table at an exact predetermined time.

Another important aspect of table game monitoring consists in identifying when a deck(s) of cards are shuffled and a “fresh” deck(s) or shoe has been started. Tracking when a shuffle happens is important because the information is necessary for tracking deck count and deck penetration, which are essential to security surveillance (for catching card counters for instance). A product called MP21 offered by Bally Gaming has an electronic data entry device embedded into the table and requires a dealer to press a button at the table when a dealer introduces a fresh set of decks into game play. The issues with having electronic buttons or data entry devices at the table have been discussed in the previous paragraph.

Several references propose tracking playing cards and game outcomes by applying image processing to video captured by an overhead camera. For instance, U.S. patent application Ser. No. 11/052,941, titled “Automated Game Monitoring”, by Tran, discloses a method of recognizing a playing card positioned on a table within an overhead image and tracking a game based on recognized playing cards. An issue with such methods is that occasionally a pit supervisor may take playing cards out of the discard rack and place them back on the table in order to resolve a dispute with the customer. When the used playing cards are placed back on the table, the automated tracking system can assume that a new game has started and begin tracking a game erroneously.

### SUMMARY

It would be desirable to be provided with a method of tracking card games in an efficient manner from ambiguous sets of game data.

It would also be desirable to be provided with a method of recognizing playing cards that are in an overlapping formation in a card hand.

It would also be desirable to be provided with a method of registering a dealer at a game table in a seamless and automatic manner.

It would also be desirable to be provided with a method of detecting that a new or freshly shuffled set of playing card decks is being introduced at a game table.

It would also be desirable to be provided with a system for detecting that a set of cards placed on the table are not meant to be tracked as a new game.

According to a first embodiment of the present invention, there is provided a method of monitoring the progress of a game on a game table by efficiently establishing game states achieved during the progress, wherein each one of the states is defined by a plurality of state parameters, comprising: acquiring game data while the game is in progress; determining values of some of the parameters from at least the data and rules of the game to establish an unresolved state of the game; and updating values of at least some of the parameters from the data, the rules, and the values defining the unresolved state to establish a subsequent state of the game.

According to another embodiment of the present invention, there is provided a method of establishing boundaries of a visible portion of one of two overlapping playing cards within an image of a gaming region comprising: locating positioning features of each of the cards within the image; establishing a position order of the cards with respect to a reference point according to the features; determining whether the one playing card is overlapped according to the order and a set of rules for laying the cards; projecting edges of the one playing card, and those of the other of the cards if the one is overlapped according to results of the determining; establishing the boundaries according to the projected edges; and applying the boundaries for the purpose of recognizing the one playing card.

According to another embodiment of the present invention, there is provided a method of determining an identity of a partially visible playing card within an overhead image of a gaming region comprising: delimiting a visible portion of the card within the image; searching for pips within the portion; establishing a pip profile according to results of the searching; and determining the identity according to the profile.

According to another embodiment of the present invention, there is provided a method of generating a control signal on a game table comprising: provoking a predetermined object placement on the table; capturing an overhead image of the placement; detecting the placement within the image; and providing a control signal in response to the detecting for monitoring purposes.

According to another embodiment of the present invention, there is provided a method of managing parameters for tracking playing cards dealt from a card deck on a game table comprising: placing a cut card within the deck; dealing some playing cards of the deck on the table; recognizing the cards as they are dealt on the table; recording card tracking parameter values as the cards are recognized; dealing the cut card; recognizing the cut card as it is dealt on the table; resetting the values in response to the recognizing the cut card; and shuffling the deck in response to the recognizing the cut card, whereby the values are seamlessly recorded and reset according to game procedures for the purpose of determining game statistics.

### BRIEF DESCRIPTION OF THE DRAWINGS

For a better understanding of embodiments of the present invention, and to show more clearly how it may be carried into effect, reference will now be made, by way of example, to the accompanying drawings which aid in understanding and in which:

FIG. 1 is an overhead view of a card game;

FIG. 2 is a side plan view of an imaging system;

FIG. 3 is a side plan view of an overhead imaging system;

FIG. 4 is a top plan view of a lateral imaging system;

FIG. 5 is a flowchart describing a method of calibrating an imaging system within the context of table game tracking;

FIG. 6 is an overhead view of a gaming table containing RFID detectors;

FIG. 7 is a block diagram of the components of an exemplary embodiment of a system for tracking gaming objects;

FIG. 8 illustrates card hand representations;

FIG. 9A illustrates non-overlapping playing cards;

FIG. 9B illustrates overlapping playing cards;

FIG. 10 illustrates an area of overlap in a playing card hand;

FIG. 11 illustrates V-style dealing of cards to a card hand;

FIG. 12 is a flowchart describing a method of determining boundaries of a partially visible playing card according to the present invention;

FIG. 13 is an overhead view of three overlapping cards within a portion of a dealing region;

FIG. 14 is an overhead view of three overlapping cards and their areas of overlap;

FIG. 15 is an overhead view of a deck of playing cards fanned out within the dealing region;

FIG. 16 is a flowchart describing a method of identifying a partially visible playing card according to the present invention;

FIG. 17A illustrates two overlapping playing cards where a constellation of pips of one of the two cards is partially visible;

FIG. 17B illustrates two overlapping playing cards where pip constellations are fully visible;

FIG. 18 is a block diagram showing the components of a Positioning and Identity Module;

FIG. 19 is a flowchart describing the preferred method of performing Detection and Search;

FIG. 20 is a flowchart describing the preferred method of pip pattern detection and index recognition;

FIG. 21 illustrates exemplary templates that may be used to perform index recognition;

FIG. 22 is an illustrative example of the front and back buffer of data frames;

FIG. 23 is an illustrative example of states with backward tracking;

FIG. 24 is an illustrative example of states with forward tracking;

FIGS. 25A and B combine to provide a flowchart describing the process of state tracking;

FIG. 26 is a flowchart of the process of backward tracking;

FIG. 27 is an illustrative example of backward tracking;

FIG. 28 is a flowchart of the process of forward tracking;

FIG. 29 is an illustrative example of forward tracking;

FIG. 30A and B combine to provide a flowchart describing a preferred method of tracking a card game according to the present invention;

FIG. 31 is an overhead view of a card game;

FIG. 32 represents an overhead image of the game table captured following the one illustrated in FIG. 31, and where each card hand is visible and comprised of two cards;

FIG. 33 represents an overhead image of the game table captured following the one illustrated in FIG. 32, and where a view of one of the card hands is occluded;

FIG. 34 represents an overhead image of the game table captured following the one illustrated in FIG. 33, and where the view of the card hand is no longer occluded;

FIG. 35 represents an alternate overhead image of the game table captured following the one illustrated in FIG. 33, and where the view of the card hand is no longer occluded but the card hand remains undetected;

FIG. 36 represents an overhead image of the game table captured at the end of the game, following the one illustrated in FIG. 35, and where the card hand remains undetected;

FIG. 37 is a flowchart of the process of player tracking;

FIG. 38 is a flowchart of the process of surveillance;

FIG. 39 is a flowchart of the process of utilizing surveillance data;

FIG. 40 is a flowchart describing a method of controlling card tracking parameters when a cut card is reached;

FIG. 41 illustrates a Dealer ID card, a Shuffle card, and a Pause card; and

FIG. 42 is an overhead view of a game table where a cut card and a dealer ID card are placed within designated regions on the table.

### DETAILED DESCRIPTION

In the following description of exemplary embodiments we will use the card game of blackjack as an example to illustrate how the embodiments may be utilized.

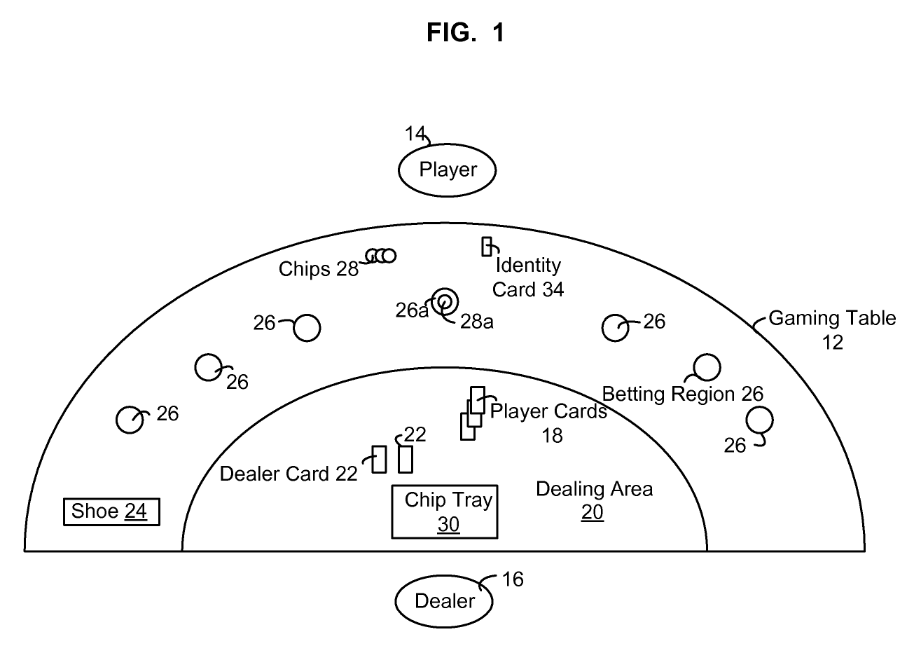

Referring now to FIG. 1, an overhead view of a card game is shown. More specifically, FIG. 1 is an example of a blackjack game in progress. A gaming table is shown as a feature 12. A feature 14 is a single player and a feature 16 is the dealer. The player 14 has three cards 18 dealt by the dealer 16 within a dealing area 20. The dealer's cards are shown as a feature 22. In this example the dealer 16 utilizes a card shoe 24 to deal the cards 18 and 22 and places them in the dealing area 20. Within the gaming table 12 there are a plurality of betting regions 26 in which the player 14 may place a bet. A bet is placed through the use of chips 28. The chips 28 are wagering chips used in a game, examples of which are plaques, jetons, wheelchecks, Radio Frequency Identification Device (RFID) embedded wagering chips and optically encoded wagering chips.

An example of a bet being placed by the player 14 is shown as chips 28a within a betting region 26a. The dealer 16 utilizes a chip tray 30 to receive and provide the chips 28. An optional feature is a player identity card 34, which may be utilized by the present invention to identify the player 14.

At the beginning of every game, the players 14 that wish to play place their wager, usually in the form of the chips 28, in the betting regions 26 (also known as betting circles or wagering areas). The chips 28 can be added to the betting regions 26 during the course of the game as per the rules of the game being played. The dealer 16 then initiates the game by dealing the playing cards 18, 22. Playing cards can be dealt either from the dealer's hand, or from a card dispensing mechanism such as the shoe 24. The shoe 24 can take different embodiments including non-electromechanical types and electromechanical types. The shoe 24 can be coupled to an apparatus (not shown) to read, scan or image cards being dealt from the shoe 24. The dealer 16 can deal the playing cards 18, 22 into the dealing area 20. The dealing area 20 may have a different shape or a different size than shown in FIG. 1. The dealing area 20, under normal circumstances, is clear of foreign objects and usually only contains the playing cards 18, 22, the dealer's body parts and predetermined gaming objects such as chips, currency, the player identity card 34 and dice. The player identity card 34 is an identity card that the player 14 may possess, which is used by the player to provide identity data and assist in obtaining complimentary (“comps”) points from a casino. The player identity card 34 may be used to collect comp points, which in turn may be redeemed later on for comps.

During the progression of the game, the playing cards 18, 22 may appear, move, or be removed from the dealing area 20 by the dealer 16. The dealing area 20 may have specific regions outlined on the table 12 where the cards 18, 22 are to be dealt in a certain physical organization otherwise known as card sets or “card hands”, including overlapping and non-overlapping organizations.

For the purpose of this disclosure, chips, cards, card hands, currency bills, player identity cards and dice are collectively referred to as gaming objects. In addition the term “gaming region” is meant to refer to any section of the gaming table 12 including the entire gaming table 12.

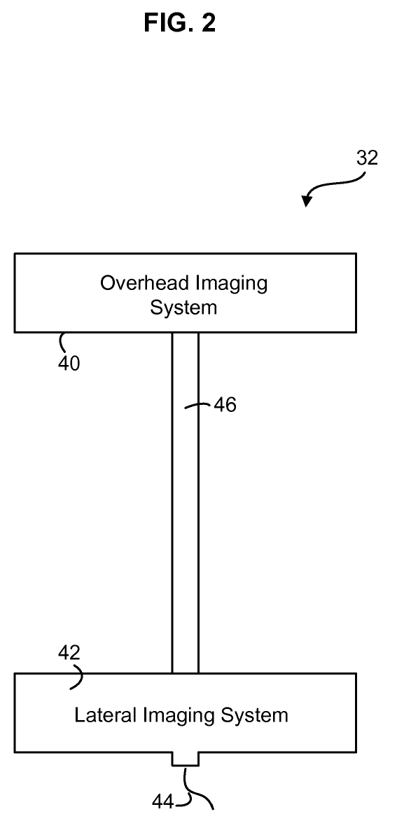

Referring now to FIG. 2, a side plan view of an imaging system is shown. An imaging system 32 comprises an overhead imaging system 40 and an optional lateral imaging system 42. The imaging system 32 can be located on or beside the gaming table 12 to image a gaming region from a top view and/or from a lateral view. The overhead imaging system 40 can periodically image a gaming region from a planar overhead perspective. The overhead imaging system 40 can be coupled to the ceiling or to a wall or any location that would allow an approximate top view of the table 12. The optional lateral imaging system 42 can image a gaming region from a lateral perspective. The imaging systems 40 and 42 are connected to a power supply and a processor (not shown) via a wiring 44 which runs through a tower 46.

The imaging system 32 utilizes periodic imaging to capture a video stream at a specific number of frames over a specific period of time, such as for example, thirty frames per second. Periodic imaging can also be used by the imaging system 32 when triggered via software or hardware means to capture an image upon the occurrence of a specific event. An example of a specific event would be if a stack of chips were placed in one of the betting regions 26. An optical chip stack or chip detection method utilizing the overhead imaging system 40 can detect this event and can send a trigger to the lateral imaging system 42 to capture an image of the one betting region 26. In an alternative embodiment the overhead imaging system 40 can trigger an RFID reader to identify the chips. Should there be a discrepancy between the two means of identifying chips the discrepancy can be flagged.

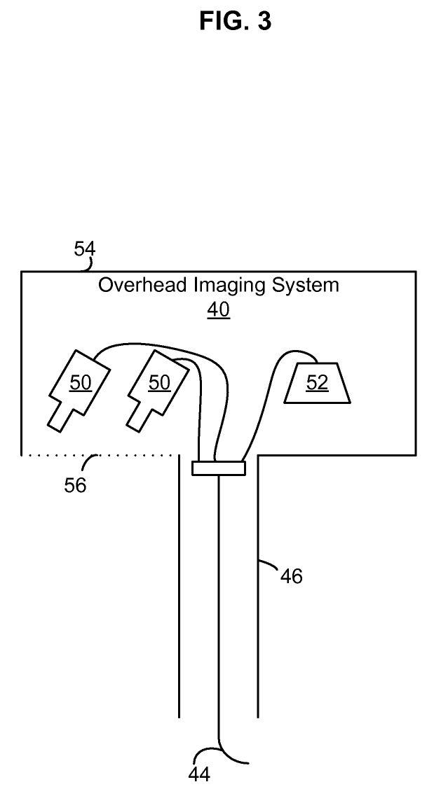

Referring now to FIG. 3, a side plan view of an overhead imaging system is shown. The overhead imaging system 40 comprises one or more imaging devices 50 and optionally one or more lighting sources (if required) 52 which are each connected to a wiring 44. Each of the imaging devices 50 can periodically produce images of a gaming region. Charged Coupling Device (CCD) sensors, Complementary Metal Oxide Semiconductor (CMOS) sensors, line scan imagers, area-scan imagers and progressive scan imagers are examples of the imaging devices 50. The imaging devices 50 may be selective to any frequency of light in the electromagnetic spectrum, including ultra violet, infra red and wavelength selective. The imaging devices 50 may be color or grayscale. The lighting sources 52 may be utilized to improve lighting conditions for imaging. Incandescent, fluorescent, halogen, infra red and ultra violet light sources are examples of the lighting sources 52.

An optional case 54 encloses the overhead imaging system 40 and if so provided, includes a transparent portion 56, as shown by the dotted line, so that the imaging devices 50 may view a gaming region.

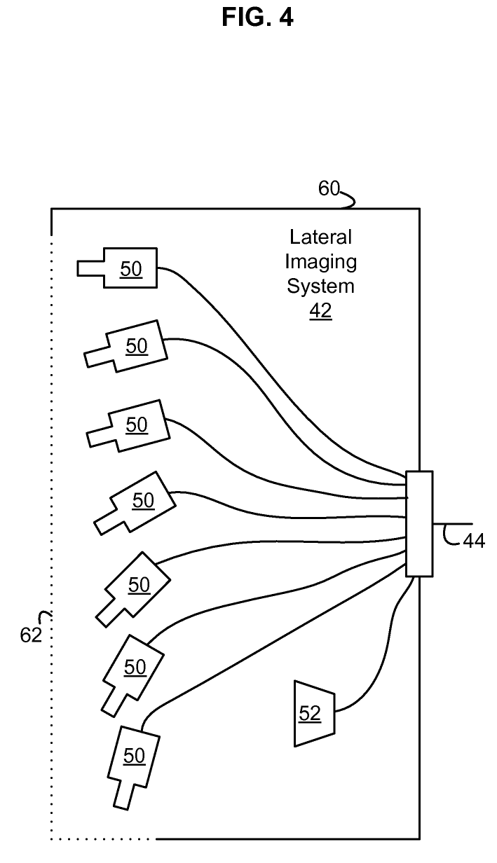

Referring now to FIG. 4, a top plan view of a lateral imaging system is shown. The lateral imaging system 42 comprises one or more of the imaging devices 50 and the optional lighting sources 52 as described with reference to FIG. 3.

An optional case 60 encloses the lateral imaging system 42 and if so provided includes a transparent portion 62, as shown by the dotted line, so that the imaging devices 50 may view a gaming region.

The examples of the overhead imaging system 40 and the lateral imaging system 42 are not meant by the inventors to restrict the configuration of the devices to the examples shown. Any number of the imaging devices 50 may be utilized and if a case is used to house the imaging devices 50, the transparent portions 56 and 62 may be configured to scan the desired gaming regions.

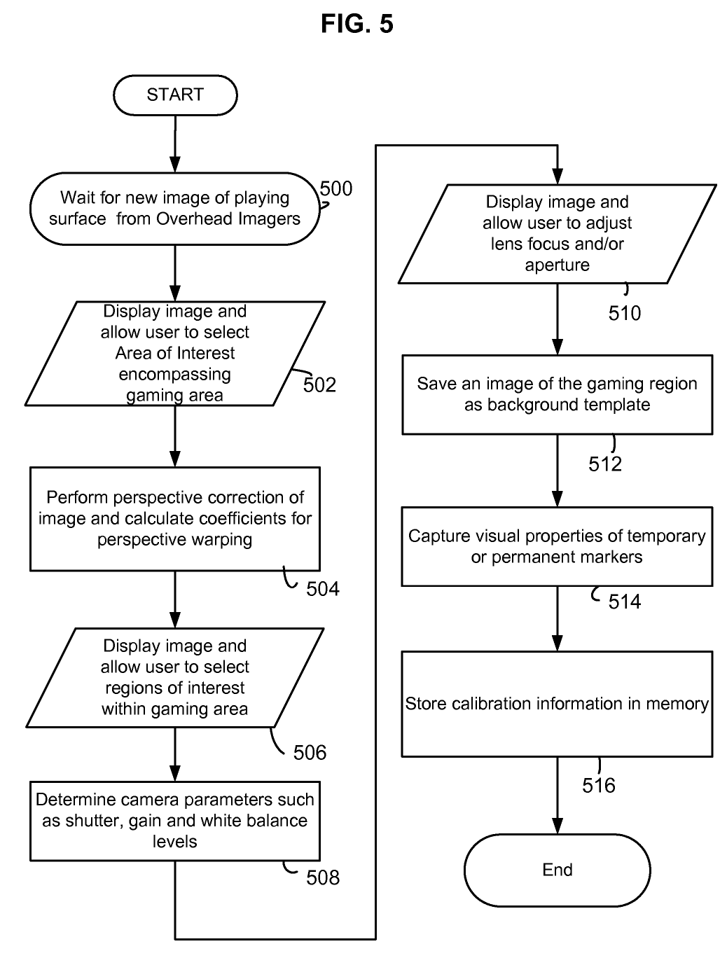

According to one embodiment of the present invention, a Calibration Module assigns parameters for visual properties of the gaming region. FIG. 5 is a flowchart describing the operation of the Calibration Module as applied to the overhead imaging system. The calibration process can be: manual, with human assistance; fully automatic; or semi automatic.

Referring back to FIG. 5, a first step 500 consists in waiting for an image of the gaming region from the overhead imager(s). The next step 502 consists in displaying the image to allow the user to select the area of interest where gaming activities occur. For instance, within the context of blackjack gaming, the area of interest can be a box encompassing the betting boxes, the dealing arc, and the dealer's chip tray.

In a step 504, coefficients for perspective correction are calculated. Such correction consists in an image processing technique whereby an image can be warped to any desired view point. Its application is particularly useful if the overhead imagers are not located directly overhead and the view of the gaming region is slightly warped because of an angled viewpoint. A perfectly overhead view point would be best for further image analysis. A checkerboard or markers on the table may be utilized to assist with calculating the perspective correction coefficients.

Subsequently, in a step 506, the resulting image is displayed to allow the user to select specific points or regions of interest within the gaming area. For instance, the user may select the position of betting spots and the region encompassing the dealer's chip tray. Other specific regions or points within the gaming area may be selected.

In the next step 508, camera parameters such as shutter value, gain value(s) are calculated and white balancing operations are performed. Numerous algorithms are publicly available to one skilled in the art for performing camera calibration.

In a step 510, additional camera calibration is performed to adjust the lens focus and aperture.

Once the camera calibration is complete and according to a step 512, an image of the table layout, clear of any objects on its surface, is captured and saved as a background image. Such an image may be for detecting objects on the table. The background image may be continuously captured at various points during system operation in order to have a most recent background image.

In a step 514, while the table surface is still clear of objects additional points of interest such as predetermined markers are captured.

In the final step 516, the calibration parameters are stored in memory.

It must be noted that the calibration concepts may be applied for the lateral imaging system as well as other imaging systems.

In an optional embodiment, continuous calibration checks may be utilized to ensure that the initially calibrated environment remains relevant. For instance a continuous brightness check may be performed periodically, and if it fails, an alert may be asserted through a feedback device indicating the need for re-calibration. Similar periodic, automatic checks may be performed for white balancing, perspective correction, and region of interest definition.

As an example, if lighting in the gaming region changes, calibration may need to be performed again. A continuous brightness check may be applied periodically and if the brightness check fails, an alert may be asserted through one of the feedback devices indicating the need for re-calibration. Similar periodic, automatic checks may be performed for white balancing, perspective correction, and the regions of interest.

In an optional embodiment, a white sheet similar in shade to a playing card surface may be placed on the table during calibration in order to determine the value of the white sheet at various points on the gaming table and consequently the lighting conditions at these various points. The recorded values may be subsequently utilized to determine threshold parameters for detecting positions of objects on the table.

It must be noted that not all steps of calibration need human input. Certain steps such as white balancing may be performed automatically.

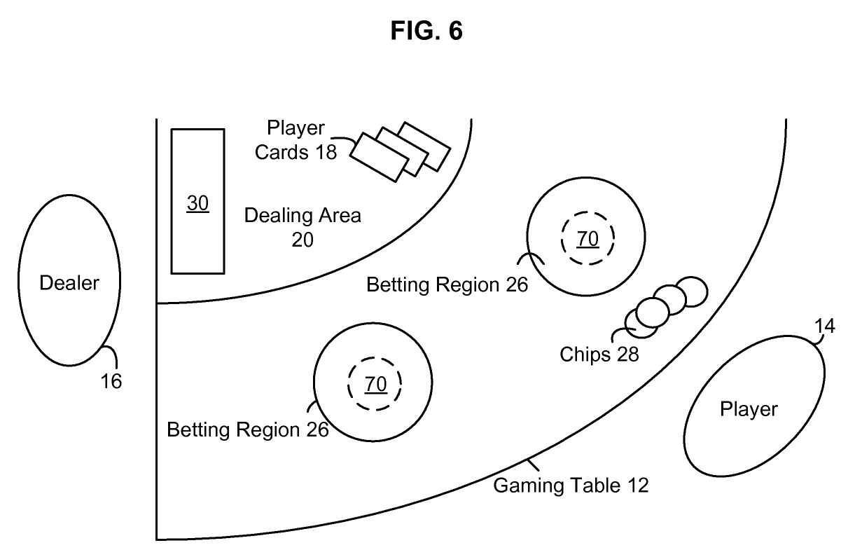

In addition to the imaging systems described above, exemplary embodiments may also make use of RFID detectors for gambling chips containing an RFID. FIG. 6 is an overhead view of a gaming table containing RFID detectors 70. When one or more chips 28 containing an RFID are placed on the RFID detectors 70 situated below the betting regions 26, the values of the chips 28 can be detected by the RFID detectors 70. The same technology may be utilized to detect the values of RFID chips within the chip tray 30.

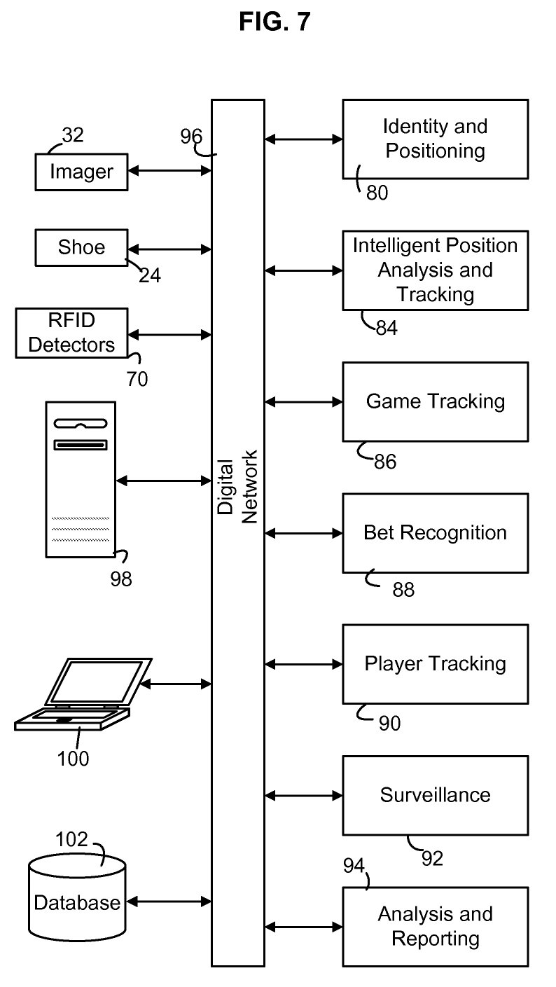

Referring now to FIG. 7, a block diagram of the components of an exemplary embodiment is shown. An Identity and Positioning Module (IP Module) 80 identifies the value and position of cards on the gaming table 12. An Intelligent Position Analysis and Tracking Module (IPAT Module) 84 performs analysis of the identity and position data of cards and interprets them intelligently for the purpose of tracking game events, game states and general game progression. A Game Tracking Module (GT Module) 86 processes data from the IPAT Module 84 and keeps track of game events and game states. The GT Module 86 can optionally obtain input from a Bet Recognition Module 88. The Bet Recognition Module 88 identifies the value of wagers placed at the game. A Player Tracking Module 90 keeps track of patrons and players that are participating at the games. A Surveillance Module 92 records video data from imaging system 32 and links game event data to recorded video. The Surveillance Module 92 provides efficient search and replay capability by way of linking game event time stamps to the recorded video. An Analysis and Reporting Module 94 analyzes the gathered data in order to generate reports on players, tables and casino personnel. Example reports include reports statistics on game related activities such as profitability, employee efficiency and player playing patterns. Events occurring during the course of a game can be analyzed and appropriate actions can be taken such as player profiling, procedure violation alerts or fraud alerts. A Dealer Tracking Module 95 identifies dealers assigned to game tables and records their shifts. It also associates recorded game data to corresponding dealers. Finally, it detects the occurrence of critical game events and adjusts game tracking activities accordingly. For instance, it resets card tracking parameters when a deck of cards is shuffled and pauses game monitoring activities when a hand of cards is backed up.

The Modules 80 to 94 communicate with one another through a network 96. A 180 Mbps Ethernet Local Area Network or Wireless Network can be used as a digital network. The digital network is not limited to the specified implementations, and can be of any other type, including local area network (LAN), Wide Area Network (WAN), wired or wireless Internet, or the World Wide Web, and can take the form of a proprietary extranet.

A Controller 98 such as a processor or multiple processors can be employed to execute the Modules 80 to 94 and to coordinate their interaction amongst themselves, with the imaging system 32 and with input/output devices 100, the optional shoe 24 and the optional RFID detectors 70. Further, the Controller 98 utilizes data stored in a database 102 for providing operating parameters to any of the Modules 80 to 94. The Modules 80 to 94 may write data to the database 102 or collect stored data from the database 102. The Input/Output devices 100, such as a laptop computer, may be used to input operational parameters into the database 102. Examples of operational parameters are the position coordinates of the betting regions 26 on the gaming table 12, position coordinates of the dealer chip tray 30, game type and game rules.

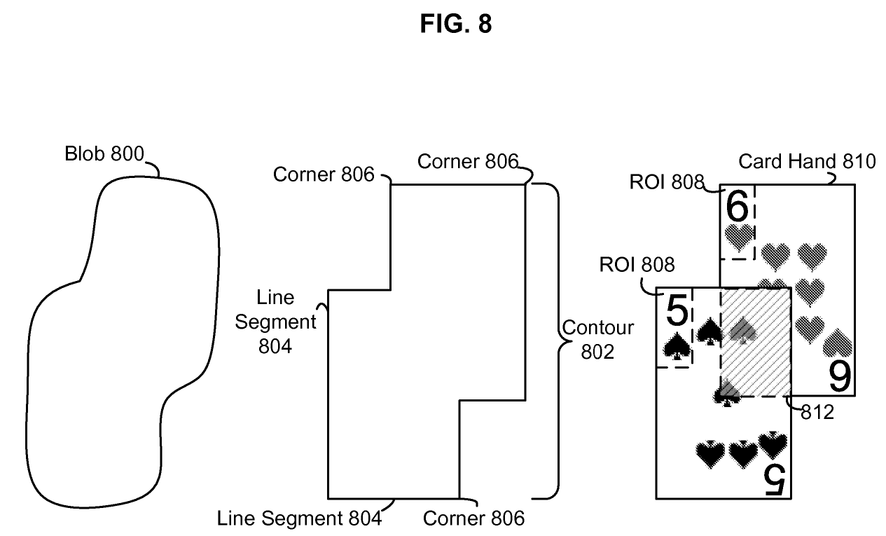

Before describing how the present invention may be implemented we first provide some preliminary definitions. Referring now to FIG. 8, a plan view of card representations is shown. A card or card hand is first identified by an image from the imaging system 32 as a blob 800. A blob may be any object in the image of a gaming area but for the purposes of this introduction we will refer to the blobs 800 that are cards and card hands. The outer boundary of the blob 800 is then traced to determine a contour 802 which is a sequence of boundary points forming the outer boundary of a card or a card hand. In determining a contour, digital imaging thresholding is used to establish thresholds of grey. In the case of a card or card hand, the blob 800 would be white and bright on a table. From the blob 800 a path is traced around its boundary until the contour 802 is established. The contour 802 is then examined for regions of interest (ROI) 808, which identify a specific card. Although in FIG. 8, the ROI 808 has been shown to be the rank and suit of a card an alternative ROI could be used to identify the pip pattern of a card. A pip is a mark located in a central region of a non-face playing card; it is used to indicate suit and rank. More specifically, the shape of a pip indicates a suit, and the number of pips indicates a rank of a corresponding, non-face playing card. Using the information obtained from the ROIs 808, it is possible to identify cards in a card hand 810.

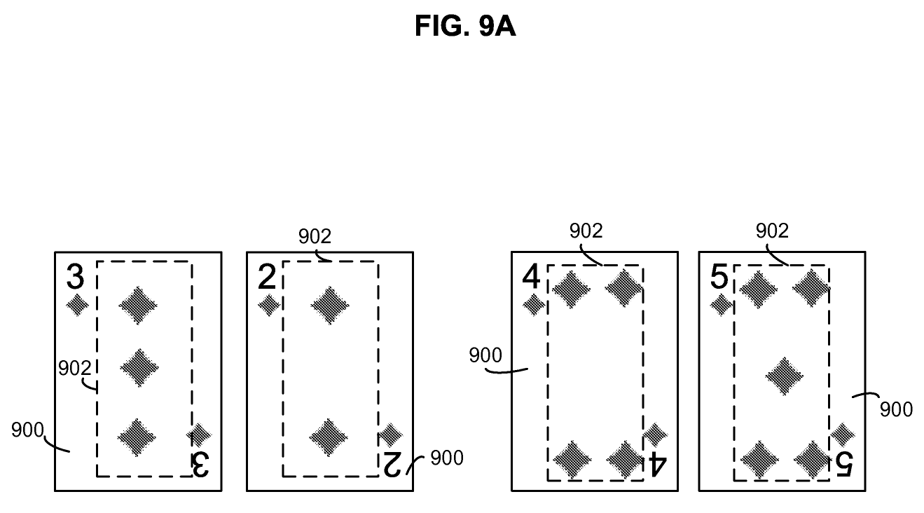

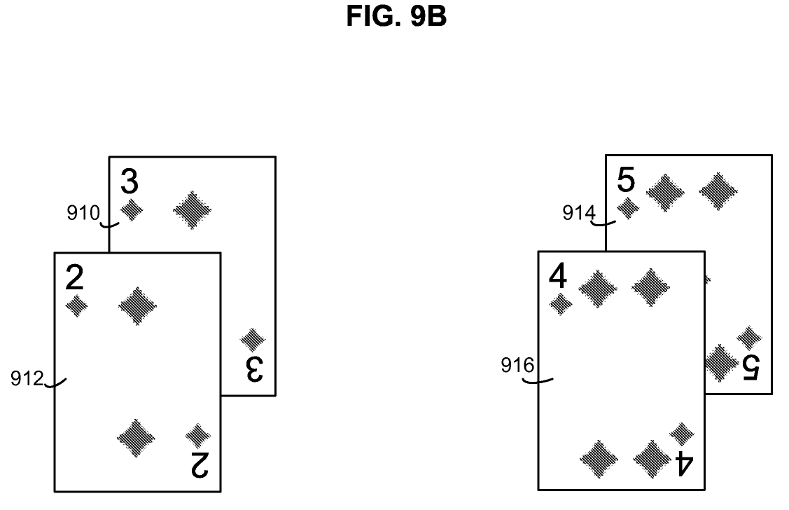

Referring now to FIG. 9A, four non-overlapping cards 900 are shown. These cards 900 can be recognized by detecting and analyzing their distinct and entirely visible pip patterns 902, which are typically located in the central region of playing cards.

In FIG. 9B, two pairs of overlapping cards are shown. The first pair is comprised of a card 910, a Three of Diamonds, and a card 912, a Two of Diamonds. The card 912 overlaps the card 910 such that the central region of the card 910 is partially covered and the pip pattern of the card 910 is not entirely visible. The card 910 is not identifiable from the resulting partially visible pip pattern.

Still referring to FIG. 9B, the second pair is comprised of a card 914, a Five of Diamonds, and a card 916, a Four of Diamonds. The card 916 overlaps the card 914 such that the central region of the card 914 is partially covered. However, the pip pattern of the card 914 remains entirely visible. As a result, the card 914 is identifiable from its entirely visible pip pattern.

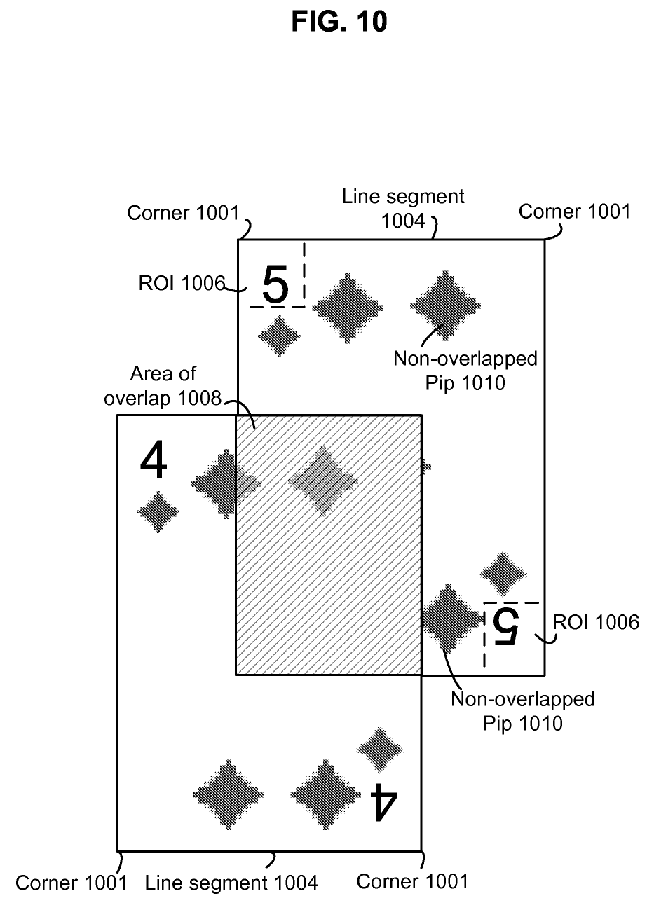

Referring now to FIG. 10, the cards Five of Diamonds and Four of Diamonds are overlapped. Card positioning features such as card corners 1001 and card edge segments 1004 can be utilized to project the boundary of each playing card based on predetermined dimensions of the card. These projected boundaries will have an Area of Overlap 1008. In a game of Blackjack, the card (Four of Diamonds) that is closer to the dealer location is usually the card that physically resides on top of the card that is farther from the dealer location. In this example, we determine that the Four of Diamonds overlaps the other card. The Area of Overlap 1008 represents the region where the Four Diamonds card overlaps the other card. Because we assume that generally the card located closest to the dealer is not covered, we can identify the card as Four of Diamonds from the entire pip pattern. However, since the Area of Overlap covers a significant portion of the other card (farther from the dealer), we can determine that it is not possible to accurately recognize the second card using the pip pattern alone. In such a scenario, the underlying card (Five of Diamonds) must be recognized from the index in an ROI 1006.

It is important to note that the order of cards in the card hands is instrumental in determining which card overlaps which. For example, when we have three overlapped cards in a hand, there will likely be more than one area of overlap. In such a scenario, we begin with the card that is likely the most recent card in the hand (closest to the dealer in most cases) and assume that the entire pip pattern is visible for this most recent card. We then determine the area of overlap where this card overlaps the next underlying card. We recognize that this second card is fully visible except for the region of overlap it has with the first (most recent) card and extract the appropriate partial pip pattern. We then move on to the third card (usually farther from the dealer location than the first two cards) and recognize that the second card overlaps this third card and detect the area of overlap. Once the area of overlap with the second card has been detected, the remaining visible partial pip pattern for the third card can be extracted.

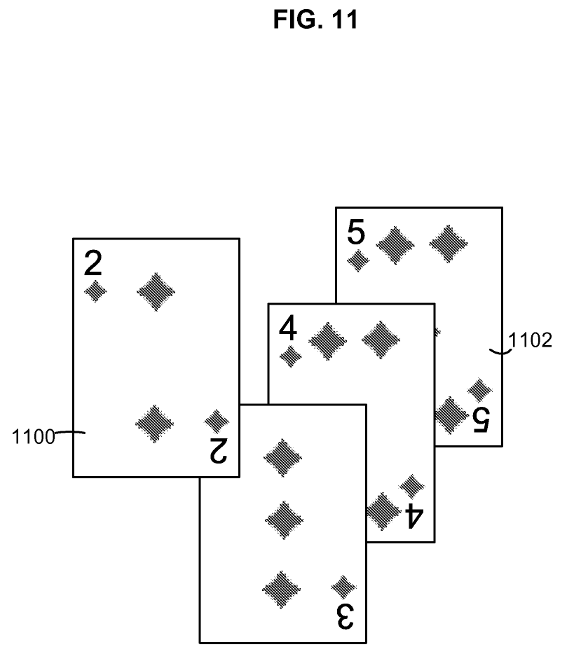

It must also be noted that in certain situations a casino dealer may deal the cards of a hand in a V-formation as illustrated in FIG. 11. In such situations, it is important to determine the most recent card (a card 1100, a Two of Diamonds, in FIG. 11) of the hand in order to detect the sequence of cards and the appropriate Areas of Overlap and order of overlap (which card is above and which is underlying). In such scenarios, shape analysis can be utilized to detect the most recent card. One such shape analysis method is to track the number of card corners. Usually the first card and last card of a hand will each have three visible card corners contrasted against the table background (a card 1102, Five of Diamonds, and the card 1100 in FIG. 11). Cards that have three such visible corners can be recognized as being first and last in the hand. Of the first and last cards in a hand, the last card will usually be located closer to the dealer. The last card can also be determined by detecting the location of the overlapping corner. In FIG. 11, the card 1100 is determined to be the last card added since the overlapping corner is the bottom right corner, while the card 1102 has its overlapping corner at the bottom left. Therefore the most recent card of a hand can be detected.

Now referring back to FIG. 10, a challenge in applying image recognition algorithms to recognize the index in the ROI 1006 is that the recognition results may have poor accuracy under stressful image conditions. Examples of stressful image conditions are insufficient image resolution, rotated or warped image, image noise or insufficient contrast. In a game such as Blackjack, in order to recognize the index in the ROI 1006, the image processing algorithm must be able to identify the index from thirteen (13) possible values (assuming Jack, Queen and King to be different). For instance, under poor resolution and with image noise, the index representing an eight (8) can look somewhat similar to an index represent a three (3). Therefore, it would be desirable to have a method to improve the accuracy of index recognition.

Still referring to FIG. 10, after identifying the area(s) of overlap, we can determine the area of the card that is not overlapped. These non-overlapped areas contain non-overlapped pips 1010. The non-overlapped pips 1010 represent a partial pip pattern that can be utilized to narrow down the potential identity of the card. For example, the non-overlapped pip pattern of the underlying card indicates that the underlying card is either a Four Diamonds or a Five Diamonds. Based on this indication we can now narrow the identification requirements of the index in the ROI 1006. By employing this method the underlying card can be recognized when the central region is overlapped and the recognition of the index in the ROI 1006 is improved by narrowing the recognition options.

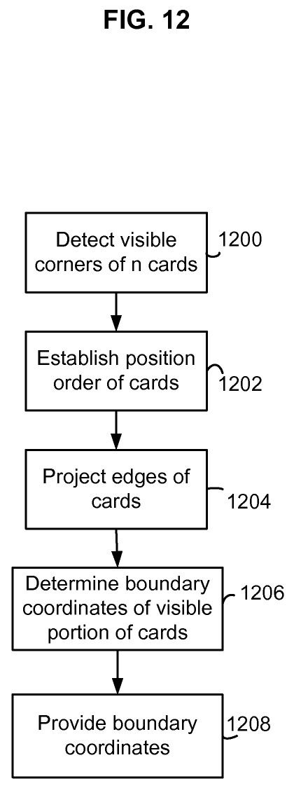

FIG. 12 is a flowchart describing a method of determining boundaries of a partially visible playing card according to a preferred embodiment of the present invention. The method is described as applied to the game of Black Jack. In a step 1200, card positioning features such as card corners and card edge segments are detected. In a step 1202, a position order of the cards is established according to the previously detected positioning features and a set of rules for laying playing cards on the table. The position order provides an indication as to the configuration of the playing cards within the hand of cards. In the particular case of Black Jack, the position order corresponds to an order of proximity from the dealer's location according to which a card is closer to the dealer position than its successors and overlaps its immediate successor. In a step 1204, edges of the cards are projected from the previously detected positioning features. In a step 1206, since the first card is not overlapped, the boundaries of its visible portion are determined as corresponding to its previously detected and projected edges. For each card n of the hand of cards, the boundaries of its visible portion is determined as corresponding to its detected edges as well as the projected edges of card n−1. Once the boundaries are delimited, their coordinates may be provided for card recognition purposes, in accordance to a step 1208.

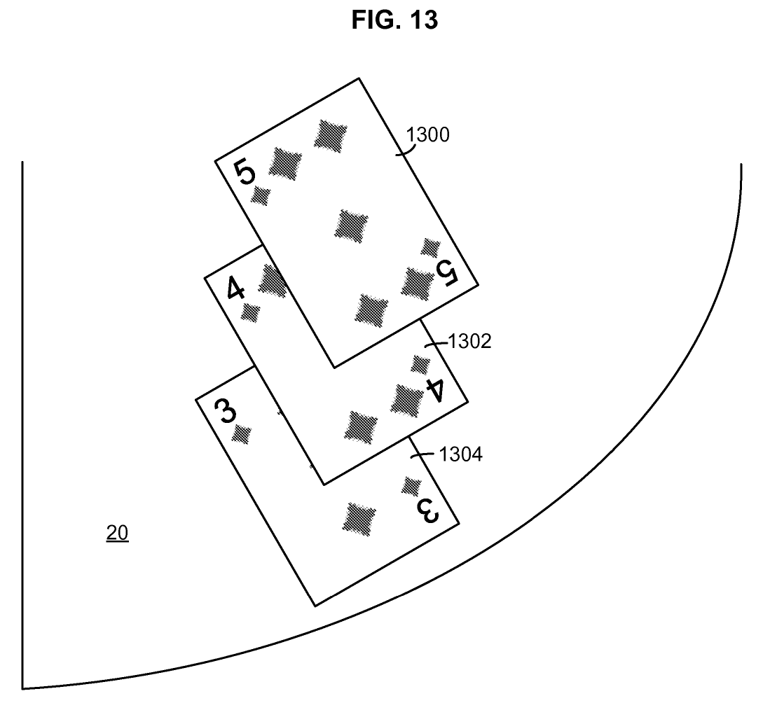

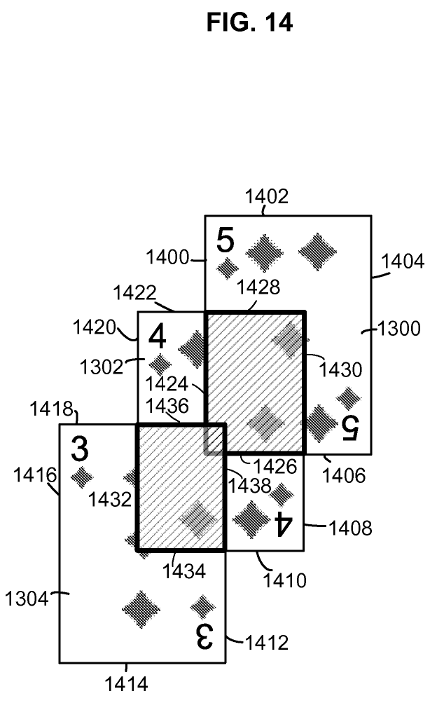

The method will now be described with respect to FIGS. 13 and 14, which illustrates a hand of cards dealt within the context of a game of Black Jack. The hand of cards is comprised of a card 1300, a Five of Diamonds, a card 1302, a Four of Diamonds, and a card 1304, a Three of Diamonds, positioned within a dealing region 20.

In the first step, and in reference to FIG. 14, edges 1402 and 1404 as well as edge segments 1400 and 1406 of the card 1300, edge segments 1408, 1410, 1420, and 1422 of the card 1302, and edges 1414, and 1416 as well as edge segments 1412 and 1418 of the card 1304 are detected.

In the second step, and still in reference to FIG. 14, a position order of the cards 1300, 1302, and 1304 is established according to the previously detected edges and edge segments 1400, 1402, 1404, 1406, 1408, 1410, 1412, 1414, 1418, 1420, and 1422. The card 1300 is assigned the first position since it is determined to be closest to the dealer's position. The card 1302 is assigned the second position since it is the second closest to the dealer's position. As for the card 1304, it is assigned the third and last position since it is the farthest from the dealer's position.

In the third step, and still in reference to FIG. 14, edge segments 1424 and 1426 of the card 1300 are projected according to the previously detected edges 1400 and 1406 of the card 1300 as well as predetermined dimensions of the playing cards. Similarly, edge segments 1428, 1430, 1432, and 1434 of the card 1302 are projected according to the previously detected edge segments 1422, 1408, 1420 and 1410 of the card 1302 as well as predetermined dimensions of the playing cards. Finally, edge segments 1436 and 1438 of the card 1304 are projected according to the previously detected edge segments 1418 and 1412 of the card 1304 as well as predetermined dimensions of the playing cards.

Subsequently, still in reference to FIG. 14, the boundaries of the visible portion of the card 1300 are determined to be the detected card edges and edge segments 1400, 1402, 1404, and 1406 as well as the projected card edge segments 1424 and 1426. This correspondence is justified by the previously established order. Indeed, the card 1300 holds the very first position and consequently, is not overlapped.

Moving on to the card 1302, the boundaries of its visible portion are determined to be detected edge segments 1408, 1410, 1420, and 1422 as well as the projected edge segments 1424 and 1426 of the card 1300, and the projected edge segments 1432 and 1434 of the card 1302. This correspondence is also justified by the previously established order. Indeed, the card 1302 holds the second position, and therefore, is overlapped by the card 1300, which holds the first position.

Finally, the boundaries of the visible portion of the card 1304 are determined to be its detected edges and edge segments 1412, 1414, 1416, and 1418 as well as the projected edge segments 1432, and 1434 of the card 1302. Once again, this correspondence is justified by the previously established order. Indeed, the card 1304 holds the third position, and therefore, is overlapped by the card 1302, which holds the second position.

Since all three cards 1300, 1302, and 1304 of the card hand have been processed, the coordinates of the boundaries of their visible portion are provided for recognition purposes.

According to one embodiment, the provided coordinates are used to analyze each of the visible portions individually within the captured image of the hand of cards in view of identifying the cards 1300, 1302, and 1304.

According to another embodiment of the present invention the provided coordinates are used to extract the visible portions of the cards 1300, 1302, and 1304 from the captured image of the hand of cards. The extracted portions are individually analyzed in order to identify the corresponding cards 1300, 1302, and 1304.

According to one embodiment of the present invention, card corners are detected instead of card edges, and the detected corners are applied to project corresponding card edges. According to another embodiment, card corners are detected in conjunction with card edges.

According to another embodiment of the present invention, card corners are detected, and cards bearing three detected corners are considered to occupy one of the first and last positions in the order, while other cards are considered to occupy an intermediate position.

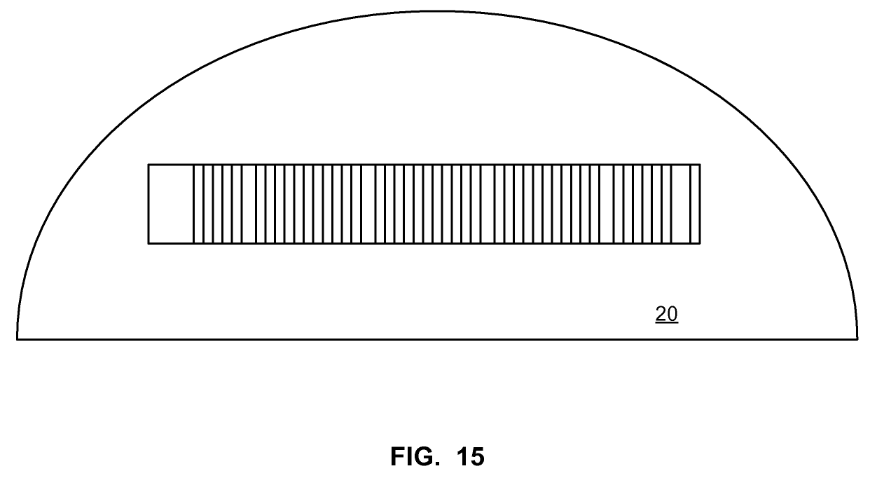

The invention is also useful for distinguishing playing cards that are fanned out for the purpose of deck checking, as illustrated in FIG. 15.

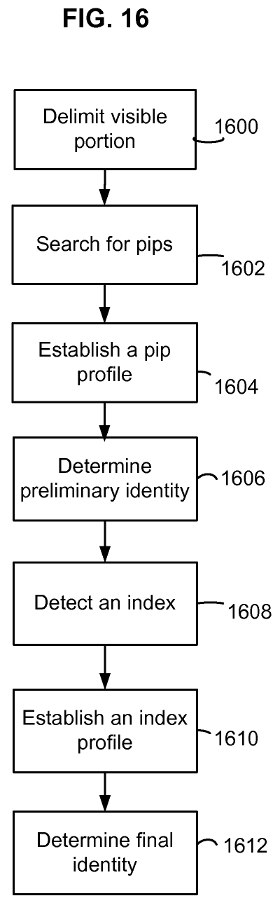

FIG. 16 is a flowchart describing a method of recognizing a partially visible playing card from an image of a hand of cards according to a preferred embodiment of the present invention.

In a step 1600, a visible portion of the card is delimited within the image according to the method illustrated in FIG. 12.

In a step 1602, the previously delimited portion is searched for pips.

In a step 1604, a pip profile is established according to results of the step 1602. The pip profile indicates the number of detected pips, the position of each detected pip with respect to the other detected pips, as well as the position of each pip with respect to positioning features of the corresponding card.

In a step 1606, the pip profile is analyzed to determine a preliminary identity of the card. The rank of the card is determined by analyzing the number of the position of each detected pip with respect to the other detected pips, as well as the position of each pip with respect to positioning features of the corresponding card. Although the card itself is partially visible, its pip constellation may be entirely visible, in which case the rank of the card is determined unambiguously. However, if its pip constellation is only partially visible, the detected pips may not be sufficient to determine the rank of the card unambiguously, in which case several candidate ranks may be proposed.

A fully visible pip profile indicating that no pips were detected is considered to belong to a card of rank Jack, Queen, or King.

In a step 1608, an index of the card is detected within the image.

In a step 1610, an index profile is established according to the previously detected index. The profile details features of the detected index.

In a step 1612, the identity of the card is determined according to the index profile and the preliminary identity established in the step 1606.

According to one embodiment of the present invention, if the card is known to be entirely visible, its pip profile may be restricted to the number of detected pips, and features of the detected pip. The suit of the card is optionally determined from the shape of the detected pips while the rank of the card is determined from the number of detected pips.

According to one embodiment of the present invention, the pip profile established in the step 1604 also indicates the shape of the detected pips. According to the same embodiment, in the step 1606, the suit of the card is determined by analyzing the recorded shape of the detected pips.

According to a preferred embodiment of the present invention, the step 1612 is performed by selecting one of several candidates established in the step 1606 according to the analysis of the index profile.

According to another embodiment, the step 1612 is performed by analyzing the index profile and comparing the results of the analysis to the preliminary identity established in the step 1606.

According to another embodiment, a reliability of the preliminary identity established in the step 1606 is evaluated. If the preliminary identity is deemed reliable, it is considered to be the final identity of the card, and the steps 1608, 1610, and 1612 are not performed. Otherwise, the steps 1608, 1610, and 1612 are performed.

According to another embodiment, if the preliminary identity established in the step 1606 proposes no more than one candidate, it is considered to be reliable as the final identity of the card, and the steps 1608, 1610, and 1612 are not performed.

According to another embodiment of the present invention, a pip region is delimited within the visible portion from the position features of the card. The step 1602 is performed exclusively within the region and therefore, more efficient.

According to another embodiment of the present invention, the step 1600 consists in: determining the positioning features of the partially visible card as well as those of the overlapping card; projecting the edges of the cards in order to identify an area of overlap; and subtracting the area from an area delimited by the edges of the partially visible card in order to delimit the visible portion, whereby the visible portion is delimited with less accuracy but within a lesser amount of time.

Although the invention has been described within the context of a playing card overlapped by one or several other playing cards, it may very well be applied to a playing card overlapped by other combinations of gaming objects.

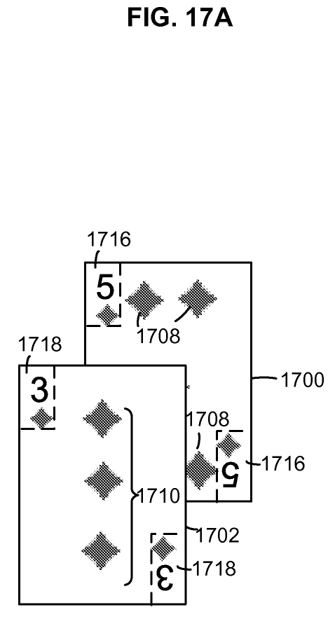

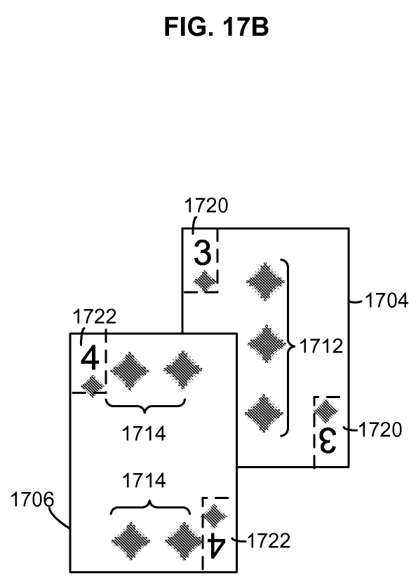

The method will now be described with reference to FIGS. 17A and 17B, each of which illustrates a hand of cards. FIG. 17A illustrates a hand of cards comprised of a card 1700, the Five of Diamonds, overlapped by a card 1702, the Three of Diamonds. FIG. 17B illustrates a hand of cards comprised of a card 1704, a Three of Diamonds, overlapped by a card 1706, a Four of Diamonds.

In the first step, a visible portion of the cards 1700 and 1702 is delimited according to the method illustrated in FIG. 12. Similarly, a visible portion of the cards 1704 and 1706 is delimited. The cards 1700 and 1704 are partially visible while the cards 1702 and 1706 are entirely visible.

In the second step, pips are searched within the previously delimited visible portions of the cards 1700, 1702, 1704, and 1706. Three pips 1708 are detected within the visible portion of the card 1700, three pips 1710 are detected within the visible portion of the card 1702, three pips 1712 are detected within the visible portion of the card 1704, and four pips 1714 are detected within the visible portion of the card 1706.

In the third step, a pip profile is established for each of the cards 1700, 1702, 1704, and 1706 according to the previously identified pips 1708, 1710, 1712, and 1714.

The pip profile of the card 1700 indicates that the three pips 1708 were detected. It also details the position of each of the pips 1708 with respect to the other pips 1708, as well as the position of each of the pips 1708 with respect to positioning features of the card 1700.

The pip profile of the card 1702 indicates that the three pips 1710 were detected. It also details the position of each of the pips 1708 with respect to the other pips 1710, as well as the position of each of the pips 1710 with respect to positioning features of the card 1702.

The pip profile of the card 1704 indicates that the three pips 1712 were detected. It also details the position of each of the pips 1712 with respect to the other pips 1712, as well as the position of each of the pips 1712 with respect to positioning features of the card 1704.

The pip profile of the card 1706 indicates that the four pips 1714 were detected. It also details the position of each of the pips 1714 with respect to the other pips 1714, as well as the position of each of the pips 1714 with respect to positioning features of the card 1706.

In the fourth step, a preliminary identity is determined for each of the cards 1700, 1702, 1704, and 1706 from their respective and previously established pip profiles.

More specifically, since the cards 1702 and 1706 are known to be entirely visible, their respective rank is determined accurately. The rank of the card 1702 is identified as Three according to the number of the detected pips 1708, the position of each of the pips 1708 with respect to the other pips 1708, as well as the position of each of the pips 1708 with respect to the positioning features of the card 1702. Similarly, the rank of the card 1706 is identified as Four according to the number of the detected pips 1714, the position of each of the pips 1714 with respect to the other pips 1714, as well as the position of each of the pips 1714 with respect to the positioning features of the card 1706.

Although the card 1704 is known to be overlapped, it benefits from a unique pip profile that may only belong to a card of rank Three. As for the card 1700, it is known to be overlapped and its pip profile is not unique; it may belong to a card of rank Four or Five. As a result, the preliminary identity of the card 1700 is comprised of two candidates: a Four or a Five.

In the fourth step, the respective indexes 1716, 1718, 1720, and 1722 of the cards 1700, 1702, 1704, and 1706 are detected.

The fifth step consists in establishing an index profile for each of the cards 1700, 1702, 1704, and 1706 according to their respective and previously detected indexes 1716, 1718, 1720, and 1722 where each profile details features of a corresponding index.

The sixth and final step consists in determining a definite identity of each of the cards 1700, 1702, 1704, and 1706 according to its respective and previously established index profile and preliminary identity. The card 1700 is recognized as a Five of Diamonds, the card 1702, as a Four of Diamond, the card 1704, as a Three of Diamonds, and the card 1706, as a Three of Diamonds.

According to one embodiment of the present invention, since the card 1702 is known to be entirely visible, its pip profile details the features and number of detected pips 1710. The suit of the card is determined from the features of the detected pips 1710, while its rank is determined from the number of detected pips 1710. Similarly, since the card 1706 is known to be entirely visible, its pip profile details the features and number of detected pips 1714. The suit of the card is determined from the features of the detected pips 1714, while its rank is determined from the number of detected pips 1714.

According to the preferred embodiment of the present invention, the final identity of the card 1700 is determined by performing an index analysis, and selecting one of the two candidates proposed by the preliminary identity, namely the Five of Diamonds, according to results of the analysis. More concretely, a pre-trained statistical classifier trained specifically to distinguish between the two candidates, namely the Four (4) and the Five (5), analyzes the index profile, and selects the appropriate candidate. It is important to note that a statistical classifier trained to distinguish between a limited number of candidate ranks is usually more accurate and efficient than a statistical classifier trained to distinguish between all thirteen ranks. Therefore, although the pip analysis performed according to the present invention does not always result in an accurate identity of a playing card, it does limit the number of candidate ranks, and allows the use of specialized statistical classifiers, thereby increasing recognition efficiency and accuracy.

According to another embodiment, the final identity of each of the cards 1700, 1702, 1704, and 1706 is determined by analyzing its respective index profile, and comparing the results of the analysis to the preliminary identity.

According to another embodiment, since the cards 1702 and 1706 are known to be entirely visible, their preliminary identity is considered to be their final identity. Consequently, the cards 1702 and 1706 are not subjected to index analysis.

According to another embodiment, since the preliminary identity of the cards 1702, 1704, and 1706 proposes no more than one candidate, it is considered to be their final identity. Consequently, the cards 1702, 1704, and 1706 are not subjected to index analysis.

The IP Module 80 may be implemented in a number of different ways. In a first embodiment, overhead imaging system 32 (see FIG. 2) located above the surface of the gaming table provides overhead images. An overhead image need not be at precisely ninety degrees above the gaming table 12. In one embodiment it has been found that seventy degrees works well to generate an overhead view. An overhead view enables the use of two dimensional Cartesian coordinates of a gaming region. One or more image processing algorithms process these overhead images of a gaming region to determine the identity and position of playing cards on the gaming table 12.

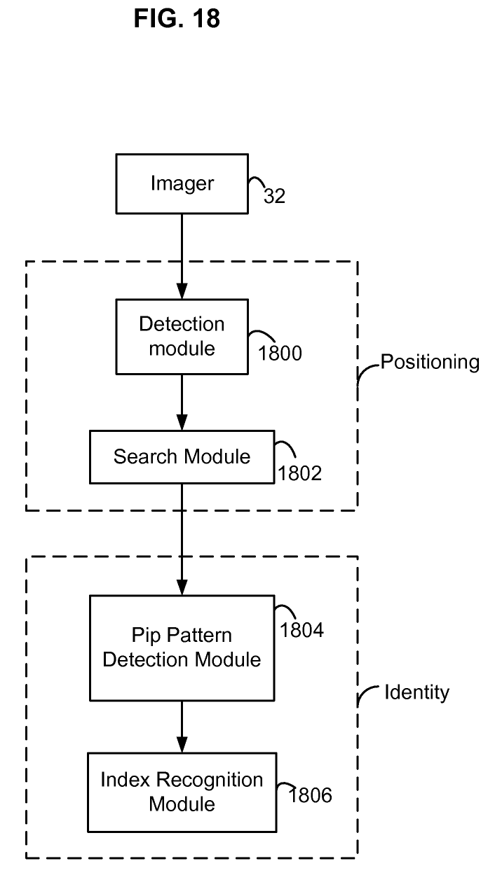

Referring now to FIG. 18 a block diagram of an embodiment of an IP Module 80 is shown. Overhead images captured by the Imager 32 are processed by a Detection Module 1800 to detect positioning features of playing cards such as for example card corners, card edge segments and contour points. Then a Search Module 1802 extracts Regions of Interest encompassing the card indices and projects boundaries of cards in order to determine areas of card overlap. After this, a Pip Pattern Detection Module 1804 analyzes areas of cards that are not overlapped and detects partial pip patterns that indicate the potential card value. Then an Index Recognition Module 1806 utilizes information about potential card value and applies appropriate recognition algorithms to the indices in the Regions of Interest in order to identify the actual card values.

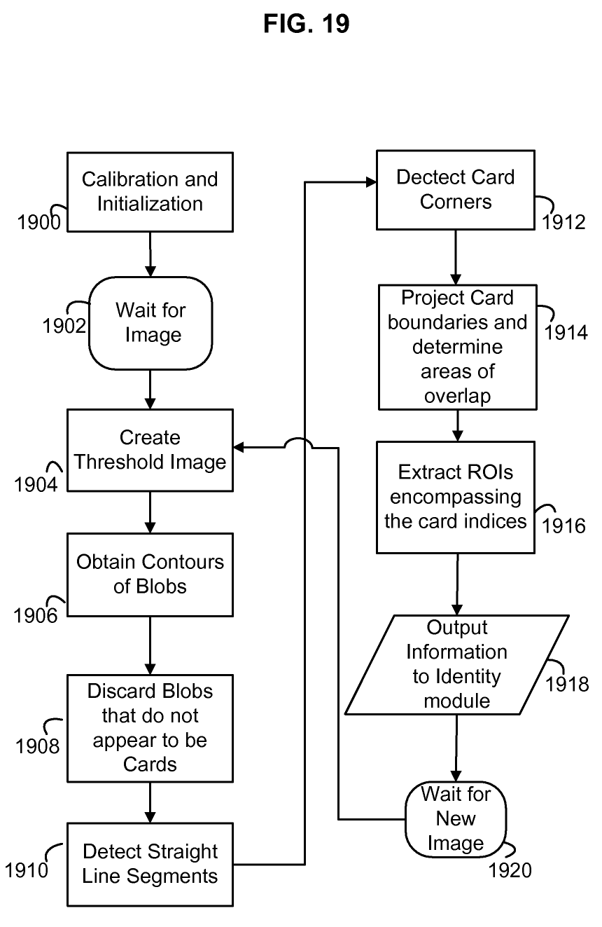

Now referring to FIG. 19, a flowchart showing the steps of Detection and Search Modules 1800 and 1802 is shown. Beginning at a step 1900, initialization and calibration of global variables occurs. Examples of calibration are manual or automated setting of camera properties for an imager 32 such as shutter value, gain levels and threshold levels. In the case of thresholds, a different threshold may be stored for each pixel in the image or different thresholds may be stored for different regions of the image. Alternatively, the threshold values may be dynamically calculated from each image. Dynamic determination of a threshold (such as adaptive threshold) would calculate the threshold level to be used for filtering out playing cards from a darker table background.

Moving to a step 1902 the process waits to receive an overhead image of a gaming region from overhead imaging system 40. At a step 1904 a thresholding algorithm is applied to the overhead image in order to differentiate playing cards from the background to create a threshold image. A background subtraction algorithm may be combined with the thresholding algorithm for improved performance. Contrast information of the playing card against the background of the gaming table 12 can be utilized to determine static or adaptive threshold parameters. Static thresholds are fixed while dynamic thresholds may vary based upon input such as the lighting on a table. The threshold operation can be performed on a gray level image or on a color image. A step 1904 requires that the surface of game table 12 be visually contrasted against the card. For instance, if the surface of game table 12 is predominantly white, then a threshold may not be effective for obtaining the outlines of playing cards. The output of the thresholded image will ideally show the playing cards as independent blobs such as the blob 800 illustrated in FIG. 8. This may not always be the case due to issues of motion or occlusion. Other bright objects such as a dealer's hand may also be visible as blobs in the thresholded image. Filtering operations such as erosion, dilation and smoothing may optionally be performed on the thresholded image in order to eliminate noise or to smooth the boundaries of a blob.

In a next step 1906, a contour, such as the contour 802 illustrated in FIG. 8, corresponding to each blob is detected. The contour can be a sequence of boundary points of the blob that more or less define the shape of a blob. The contour of a blob 800 can be extracted by traversing along the boundary points of the blob using a boundary following algorithm. Alternatively, a connected components algorithm may also be utilized to obtain the contour.

Once the contours have been obtained processing moves to a step 1908 where shape analysis is performed in order to identify contours that are likely not cards or card hands and eliminate these from further analysis. By examining the area of the contour and the external boundaries, a match may be made to the known size and/or dimensions of cards. If the contour does not match the expected dimensions of a card or card hand it can be discarded.

Moving next to a step 1910, line segments, such as the line segments 804 illustrated in FIG. 8, forming the card and card hand boundaries are extracted. One way to extract the line segments is to traverse along the boundary points of the contour and test the traversed points with a line fitting algorithm. Another potential line detection algorithm that may be utilized is a Hough Transform. At the end of the step 1910, the line segments forming the card or card hand boundaries are obtained. It is to be noted that, in alternate embodiments, the straight line segments of the card and card hand boundaries may be obtained in other ways. For instance, the straight line segments can be obtained directly from an edge detected image. For example, an edge detector such as the Laplace edge detector can be applied to the source image to obtain an edge map of the image from which the straight line segments can be detected. These algorithms are non-limiting examples of methods to extract positioning features, and one skilled in the art might use alternate methods to extract these card and card hand positioning features.

Moving to a step 1912, one or more corners of cards, such as the corners 806 illustrated in FIG. 8, can be obtained from the detected straight line segments 804. The card corners may be detected directly from the original image or thresholded image by applying a corner detector algorithm such as for example, using a template matching method using templates of corner points. Alternatively, the corners may be detected by traversing points along the contour and fitting the points to a corner shape. The corner points and the line segments are then utilized to create a position profile for cards and card hands, i.e. where they reside in the gaming region.

Moving to a step 1914, based on known dimensions of a playing card and based on positioning features (the line segments and/the corner points), card boundaries are projected and areas of card overlap, such as an area 812 illustrated in FIG. 8, are determined.

Moving to a step 1916, the card corners are utilized to obtain a ROI encompassing a card index located near the card corner, such as the ROI 808 illustrated in FIG. 8.

Moving to a step 1918, the ROI information and card overlap areas for each card and card hand are sent to the Identity Module for further analysis.

Finally moving to a step 1920 the method waits for a new image.

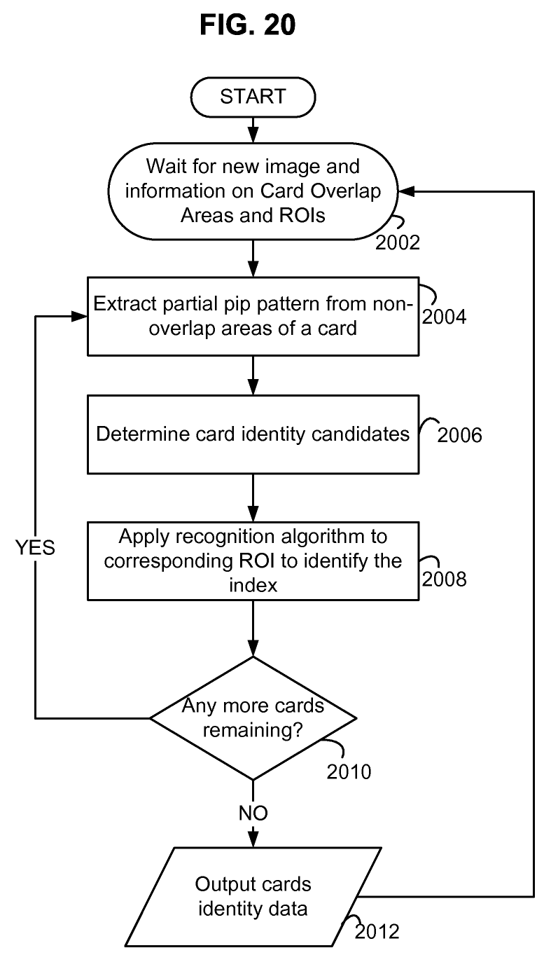

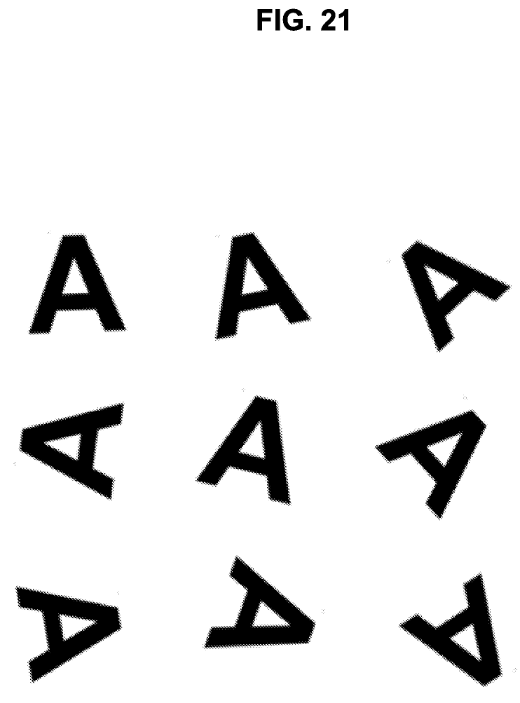

FIG. 20 is a flowchart showing steps involved in the Identity Module. The Identity Module is comprised of sub-components for pip pattern detection and index recognition.

Referring to FIG. 20, at a step 2002 the process waits for a new image and corresponding information on ROIs and card overlap areas for the card hands.

Moving to a step 2004, partial pip patterns can be extracted from the non-overlapped areas of the card hand. One method to detect the partial pip pattern is to perform a threshold operation in the non-overlapped card area in order to determine blobs representing the pips. Filtering operations such as erosion/dilation and smoothing operations can then be performed to improve the smoothness and continuity of the blobs. Blobs can then be classified as pip or not pip based on their dimensions (size/width/height etc.). The resulting pip blobs can be further analyzed using a template matching method to determine the suit. Once the suit of the pips has been determined, their relative positions with respect to each other (distance/angle) can be utilized to determine the partial pip pattern.

After detecting the partial pip pattern in a step 2004, we move to a step 2006 where we determine possible candidates for the card value based on the partial pip pattern. As an example, with reference to FIG. 10, the partial pips of the underlying card can be detected and the partial pip pattern can be ascertained to be that of either a Four or a Five valued card. An advantage of detecting the partial pip pattern and narrowing the possible value of the card is that it makes index recognition more accurate and efficient. These possible values are called the card identity candidates.

Referring back to FIG. 20, and moving to a step 2008, a recognition algorithm can be applied to the ROIs to determine which of the card identity candidates represent the true card value. In one embodiment, a template matching algorithm, such as normalized cross correlations, can be utilized to identify an index in the ROIs. For each card value a template can be captured and stored during the calibration phase (templates for A are shown by example in FIG. 21). The templates can also be obtained in a statistical manner. For example, as an average of the character templates for a given rank.

Now referring to FIG. 10, a partial pip pattern for the underlying card can be detected and it can be determined that that index in the ROI 1006 is either a Four or a Five (card identity candidates). The stored template for a Five and the template for a Four can be template matched to the ROI 1006 using a normalized cross correlation algorithm. The resulting match confidences can be compared to determine which template is a closer match to the index in the ROI 1006. The higher confidence would likely be for the template of Five and consequently it can be determined that the underlying card is a Five. In an alternate embodiment a statistical classifier can be utilized for recognition of the index in the ROI 1006. A neural network is one example of a statistical classifier that can be utilized. For example, a feed forward neural network can be specifically trained to differentiate between a Four and a Five. Similarly, for example different neural network models can be trained to differentiate between a Six and a Seven. With reference to FIG. 10, after the partial pip pattern of the underlying card has been determined, the neural network that has been trained to differentiate between a Four and Five can be chosen and applied to the ROI 1006 to determine the value of the card.

Referring back to a step 2008 of FIG. 20, based on the card identity candidates, appropriate templates (or statistical classifiers) can be chosen and applied to the region of interest to identify the index of the card.

In a next step 2010, we check to see if there are any more cards in the image to recognize and if there are more cards remaining we repeat the recognition process starting at the step 2004. Otherwise, we output the identities of the cards and move to the step 2002 to wait for a new image and new ROI and Card Overlap Area information.

An advantage of recognizing the partial pip pattern before applying template matching is that it narrows down the possible identity of the card. Consequently, fewer template matches need to be done to recognize the index, thus speeding up the recognition process. By narrowing the number of card identity candidates, it also helps improve recognition accuracy. Importantly, the method helps determine the value of the playing card when it is partially occluded.

Optionally, in a step 2008, the ROI may be pre-processed to improve recognition results. Examples of ROI pre-processing steps include thresholding the image in the ROI and/or histogram normalization. Rotation of the ROI may also be performed in order to obtain an upright index orientation. Examples of other recognition algorithms that may be utilized with the present invention include, Support Vector Machines, Hidden Markov Models and Bayesian Networks. A combination of recognition algorithms may be used to improve accuracy of recognition.

It is important to note that the index recognition step can optionally be skipped for cards where the entire pip pattern is visible and consequently the card can be recognized from the pip pattern alone. Index recognition is needed when the entire pip pattern is not visible.

We shall now describe the function of the Intelligent Position Analysis and Tracking Module (IPAT Module) 84 (see FIG. 7). The IPAT Module 84 performs analysis of the identity and position data of cards/card hands and interprets them “intelligently” for the purpose of tracking game events, game states and general game progression. The IPAT Module may perform one or more of the following tasks:
a) Object modeling;
b) Object motion tracking;
c) Points in contour test;
d) Detect occlusion of cards;
e) Set status flags for card positional features; and
f) Separate overlapping card hands into individual card hands.

We shall now discuss the functionality of the game tracking (GT) module 86 shown in FIG. 7. The GT module 86 processes input relating to card identities and positions to determine game events and game states.

For the purposes of the following description, a game state is defined by a plurality of state parameters such as the identity of a playing card dealt on the gaming table or an amount wagered by a player.

The GT module 86 can have a single state embodiment or a multiple state embodiment. In the single state embodiment, at any given time in a game, one valid current game state is maintained by the GT module 86. When faced with ambiguity of game state, the single state embodiment forces a decision such that one valid current game state is chosen. In the multiple state embodiment, multiple possible game states may exist simultaneously at any given time in a game, and at the end of the game or at any point in the middle of the game, the GT module 86 may analyze the different game states and select one of them based on certain criteria. When faced with ambiguity of game state, the multiple state embodiment allows all potential game states to exist and move forward, thus deferring the decision of choosing one game state to a later point in the game. The multiple game state embodiment can be more effective in handling ambiguous data or game state scenarios.

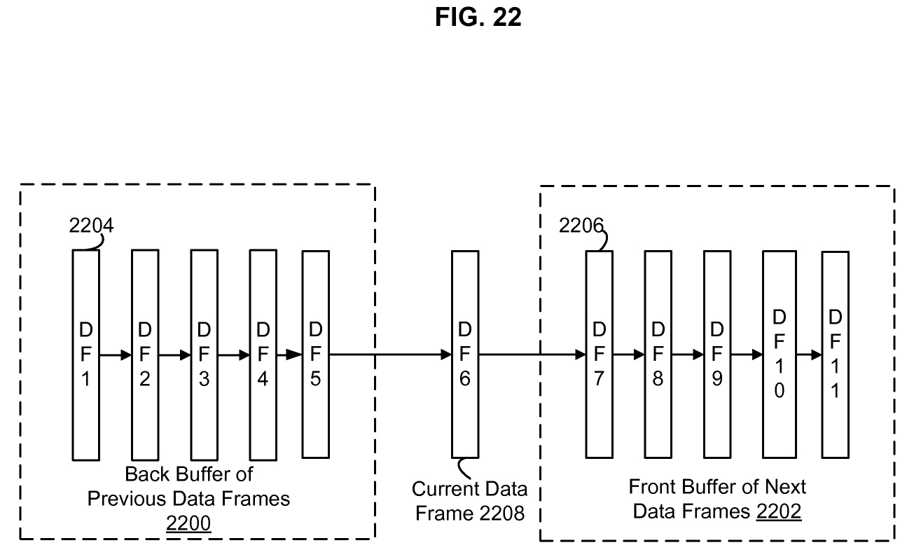

In order to determine states, the GT module 86 examines data frames. Data frames comprise data on an image provided to the GT module 86 from the IP module 80 and the IPAT module 84. Referring now to FIG. 22 an illustrative example of the front and back buffer of data frames is shown. Data frames are queued in a back buffer 2200 and a front buffer 2202. Data frames in the front buffer 2202 have yet to be examined by the GT module 86 while data frames in the back buffer 2200 have been examined. Data frame 2204 is an example of a data frame in the back buffer 2200 and the data frame 2206 is an example of a data frame in the front buffer 2202. Current data frame 2208 indicates a data frame being processed by the GT module 86.

A data frame may include the following data:
a) Card and card hand positioning features (such as contours and corners)
b) Identity of cards, linked to the card positioning features
c) Status flags (set by the IPAT module 84) associated with the card and card hand positioning features.

The GT module 86 utilizes data frames as described with regard to FIG. 22 to identify key events to move from one state to another as a game progresses. In the case of Blackjack, a key event is an event that indicates a change in the state of a game such as a new card being added to a card hand, the split of a card hand, a card hand being moved, a new card provided from a shoe, or removal or disappearance of a card by occlusion.

A stored game state may be valid or invalid. A valid state is a state that adheres to the game rules, whereas an invalid state would be in conflict with the game rules. During the game tracking process, it is possible that the current game state cannot account for the key event in the current data frame 2208 being analyzed. The data frame 2208 can contain information that is in conflict with the game rules or the current game state. In such an event, the current game state may be updated to account for the data in the frame 2208 as accurately as possible, but marked as an invalid state. As an example in Blackjack, a conflicting data frame would be when the IP module 80 or IPAT module 84 indicates that the dealer has two cards, while one of the players only has one hand with one card, which is a scenario that conflicts with Blackjack game rules. In this example, the dealer hand in the game state is updated with the second dealer card and the game is set to invalid state.

In the event of an invalid state or data frames with conflicting information, ambiguity resolution methods can be utilized to assist in accurately determining valid states. An embodiment of the present invention utilizes either or a combination of back tracking, forward tracking, and multiple game states to resolve ambiguities.

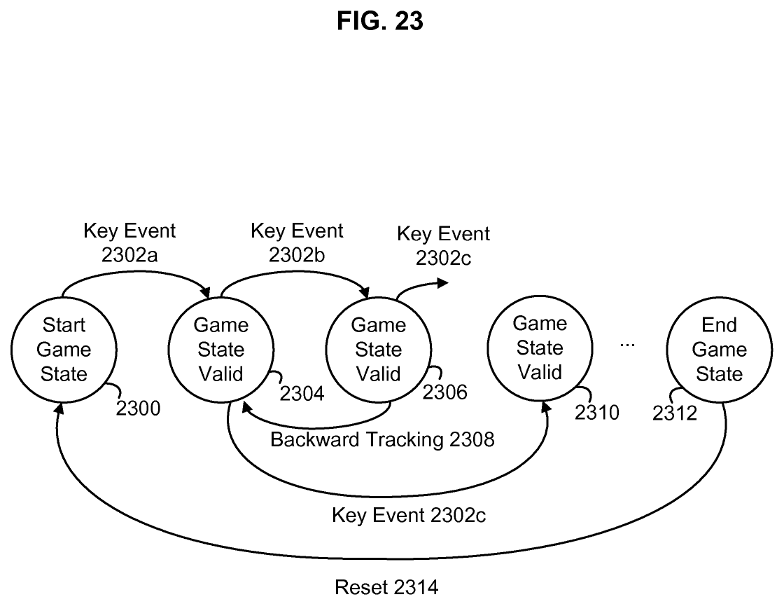

To further explain how backtracking may be utilized to resolve ambiguity with regard to key events and states we refer now to FIG. 23, an illustrative example of states with backward tracking. Beginning at a state 2300 a game is started. Based upon a key event 2302a, which is discovered to be valid, the next state is 2304. A key event 2302b is also valid and the state 2306 is established. A key event 2302c is ambiguous with respect to the state 2306 and consequently cannot establish a new state. A feature 2308 indicates backtracking to a previous game state 2304 to attempt to resolve the ambiguity of key event 2302c. At this point key event 2302c is found to be not ambiguous with respect to game state 2304 and the new state 2310 is established based upon key event 2302c to reflect this.

The use of backward tracking requires the system to store in memory previous game states and/or previous data frames. The number of temporally previous game states or data frames to be stored in memory can be either fixed to a set number, or can be variable, or determined by a key event.

Game states continue to be established until the game ends at game state 2312 and reset 2314 occurs to start a new game state 2300.

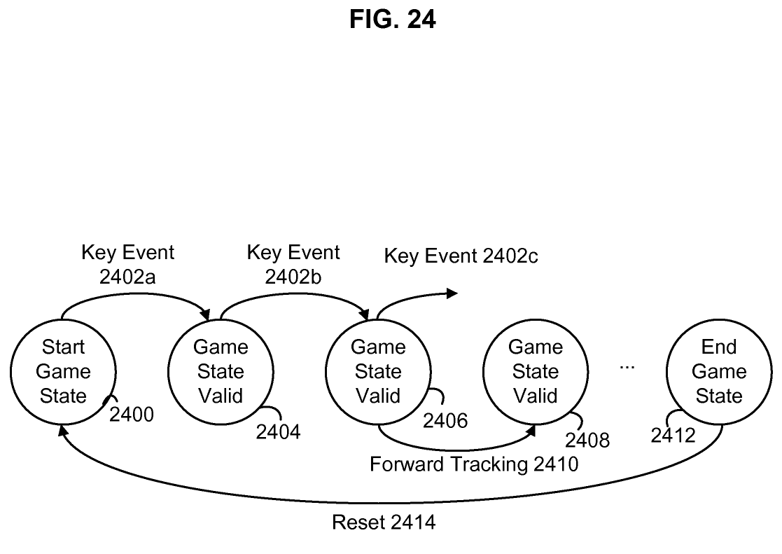

Referring now to FIG. 24, an illustrative example of states with forward tracking is shown. Beginning at state 2400 a game is started. Based upon a key event 2402a, which is discovered to be valid, the next state is 2404. Key event 2402b is valid which results in a valid game state 2406. Key event 2402c is determined to be ambiguous with respect to game state 2406. As a result, the method forward tracks through the front buffer 2202 of data frames and identifies a future key event in a data frame in front buffer 2202. The combination of key events 2402c and the future key event resolve the ambiguity, thus establishing next state 2408. Feature 2410 illustrates how ambiguity is resolved by looking for a valid future key event in front buffer 2202 and combining it with key event 2402c.

The forward tracking method requires the front buffer 2202 (see FIG. 22) store data frames in memory that are temporally after the current frame 2208 being analyzed. The number of frames to store information could either be fixed to a set number of data frames or can be variable.

Game states continue to be established until the game ends at game state 2412 and reset 2414 occurs to start a new game state 2400.

Although backward tracking and forward tracking have been described as separate processes, they may be utilized in conjunction to resolve ambiguous data. If either one fails to establish a valid state, the other may be invoked in an attempt to establish a valid state.

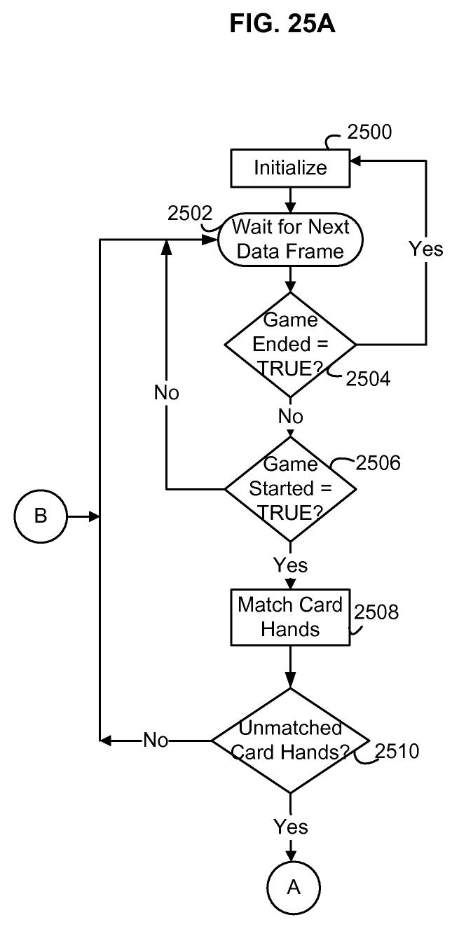

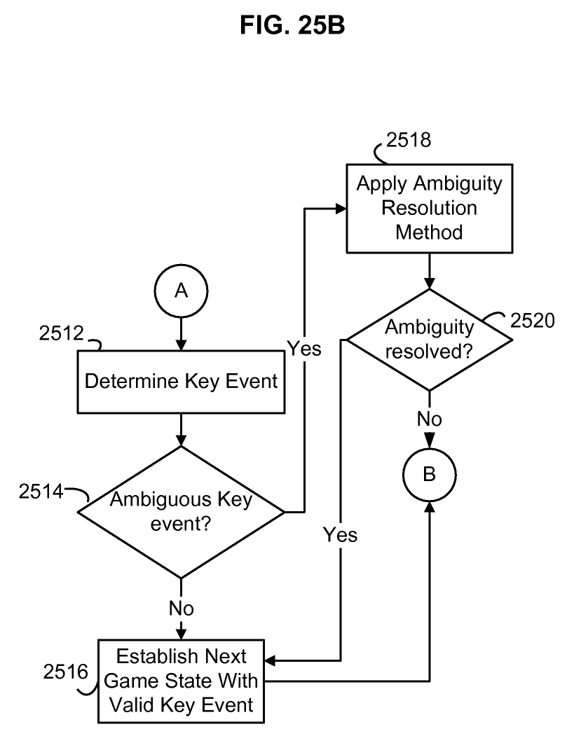

Referring now to FIGS. 25a and 25b a flowchart of the process of single state tracking is shown. Beginning at a step 2500 an initialization for the start of tracking a game begins. At the step 2500 one or more game state indicators are initialized. Examples of game state indicators would be that no card hands have been recognized, a game has not started or a game has not ended, or an initial deal has not been started. In the case of Blackjack an initial deal would be the dealing of two cards to a player. Processing then moves to a step 2502 where the process waits for the next data frame to analyze. At a step 2504 a frame has arrived and the frame is analyzed to determine if a game has ended. The step 2504 may invoke one or more tests such as:
a) Is the dealer hand complete? In the case of Blackjack, if a dealer hand has a sum more than or equal to seventeen, the dealer hand is marked complete.
b) Is step a) met and do all player card hands have at least two cards?
c) A check of motion data to determine that there is no motion in the dealer area.
d) No cards in the current frame and no motion on the table could also indicate a game has ended.
   If the game has ended, processing returns to the step 2500. If the game has not ended, then at a step 2506 a test is made to determine if a game has started. The test at the step 2506 may determine if the initial deal, denoted by two cards near a betting region 26, has occurred. If not, processing returns to the step 2502. If the game has started, then processing moves to a step 2508.

At a step 2508 the positioning features and identities of cards and card hands in the data frame are matched to the card hands stored in the current game state. The matching process can take on different embodiments such as priority fit. In the case of priority fit, card hands in the game state are ordered in priority from the right most hand (from the dealer's perspective) to the left most hand. In this ordering, the card hand at the active betting spot that is located farthest to the right of the dealer would have the highest pre-determined priority in picking cards/card hands in the data frame to match to itself. The right most card hand in the game state would pick the best match of cards/card hands from the data frame, after which the second right most card hand in the game state would get to pick the matching cards/card hands from the remaining cards/card hands in the data frame.

In an alternate embodiment of matching, a best fit approach can be used in order to maximize matching for all card hands in a game state. In the best fit approach, no specific card hand or betting location is given pre-determined priority.

In some cases a perfect match with no leftover unmatched cards or card hands occurs. This indicates that the incoming data frame is consistent with the current game state and that there has been no change in the game state.

Moving now to a step 2510 a determination is made as to whether there are any unmatched cards or card hands left from the previous step. If there are no unmatched cards or card hands the process returns to the step 2502. Unmatched cards or card hands may be an indication of a change in the game state. At a step 2512, the unmatched cards or card hands are analyzed with respect to the rules of the game to determine a key event. At a step 2514, if the determined key event was valid, the next game state is established at a step 2516, after which the process returns to the step 2502. Returning to the step 2514, if the key event is invalid or ambiguous then processing moves to a step 2518 where an ambiguity resolution method such as backtracking or forward tracking may be applied in an effort to resolve the ambiguity. At a step 2520 a test is made to determine if the ambiguity is resolved. If so, processing moves to the step 2516 otherwise if the ambiguity is not resolved, then a next game state cannot be established and as a result, processing returns to the step 2502 and waits for the next frame.

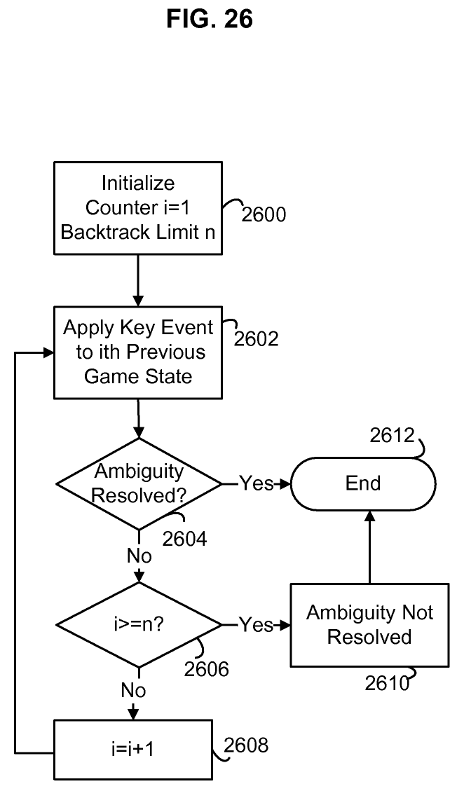

We shall now discuss how backward tracking (shown as feature 2308 of FIG. 23) functions. Referring now to FIG. 26, a flowchart of the process of backward tracking is shown.

The backward tracking process starts at step 2600 by initializing counter “i” to 1 and initializing “n” to the predetermined maximum number previous game states to backtrack to. In the next step 2602 the ambiguous key event from the single state tracking process (step 2514 of FIG. 25B) is compared to the i^{th} previous game state to see if the key event is valid with respect to this previous game state. Moving to step 2604, if the ambiguity is resolved by the comparison then backtracking has succeeded and the process ends at step 2612. In a step 2604, if the ambiguity is not resolved then the process moves to step 2606 to check if it has backtracked to the maximum limit. If the maximum limit is reached, then moving to step 2610 it is determined that backtracking has not resolved the ambiguity and the process ends at step 2612. If in a step 2606 the maximum limit has not been reached, then the process increments the counter “i” at step 2608 and returns to step 2602.

Backward tracking can be used to track to previous frames, in order to look for a valid key event, or to track to previous valid game states.

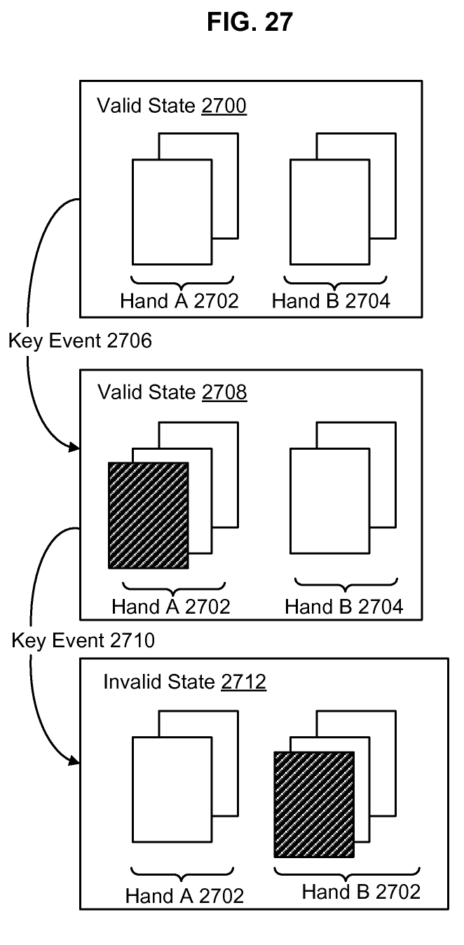

Referring now to FIG. 27 an illustrative example of backward tracking is shown. FIG. 27 shows how backward tracking can be used to backward track to a previous game state in order to resolve ambiguity. In this example, the IP Module 80 and IPAT Module 84 provide frames containing identity, location and orientation data of playing cards. In the problem scenario a valid state 2700 exists with hand A 2702 and hand B 2704 both having two cards. At the next key event 2706, the dealer accidentally dropped a card on hand A 2702 so it now contains three cards and a valid game state 2708 is established. At key event 2710 the dealer has picked up the card and placed it on hand B 2704 so that hand A 2702 now contains two cards and hand B 2704 now contains three cards resulting in an invalid game state 2712. Key event 2710 is ambiguous with respect to current game state 2708 and invalid state 2712 occurs because hand A 2702 cannot be matched between the invalid game state 2712 and the valid game state 2708. The back tracking method is then activated, and the key event 2710 is applied to previous valid game state 4180 which results in the resolution of the ambiguity and establishing of a new valid game state (not shown) similar to invalid game state 2712. The game can then continue to update with new inputs.

It is also possible that backward tracking may not be able to account for certain key events, in which case other conflict resolution methods described next can be utilized.

We shall next discuss forward tracking in more detail. Forward tracking requires a front buffer 2202 of FIG. 22 to store data frames. The number of frames to store information could either be fixed or can be variable. Data frames can be analyzed after a predetermined number of frames are present in front buffer 2202.

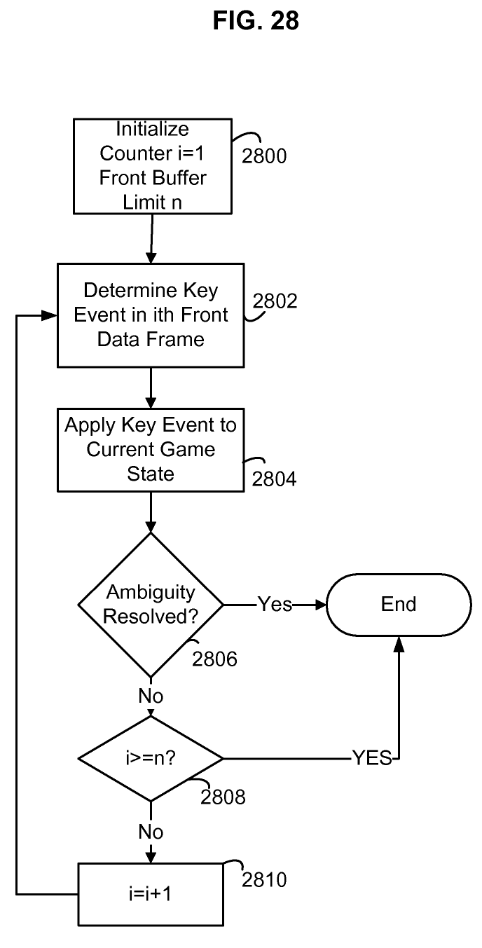

Referring now to FIG. 28 a flowchart of the process of forward tracking is shown. The forward tracking process starts at a step 2800 by initializing counter “i” to 1 and initializing “n” to the predetermined maximum number data frames in front buffer 2202. At a step 2802 the i^{th} data frame in the front buffer is analyzed to determine a key event (as described in previous sections). In a next step 2804, the key event is compared to the current game state to determine if the key event is valid and if it resolves the ambiguity. From a step 2806, if the ambiguity is resolved then forward tracking has succeeded and the process ends. If the ambiguity is not resolved then moving to a step 2808 a determination is made on whether the end of the front buffer 2202 has been reached. If the end of the front buffer has been reached then forward tracking has not been able to resolve the ambiguity and processing ends. If at step 2808, the end of the front buffer 2202 has not been reached, then the counter “i” is incremented in a step 2810, after which the process returns to step 2802.

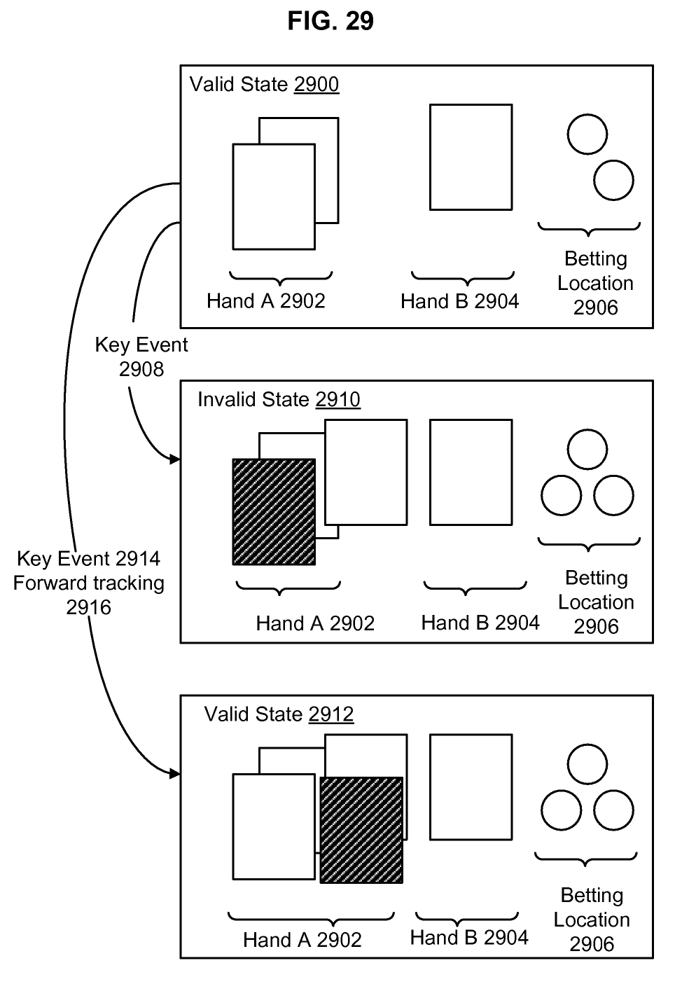

Referring now to FIG. 29 an illustrative example of forward tracking for the game of Blackjack is shown. In this forward tracking example, orientation information on playing cards is not available to the GT Module 86. Valid state 2900 indicates that there are two hands, hand A 2902 and hand B 2904, caused by one split, and there are two bets in betting location 2906. Key Event 2908 shows an additional third bet in betting location 2906, the addition of a new card to hand A 2902 and the offset top card of hand A 2902 (indicating possible overlap between two hands), and the combination of the foregoing three features indicate a potential split of Hand A 2902 or a double down onto Hand A 2902. Key event 2908 is ambiguous with respect to game state 2900 since it is uncertain whether a split or a double down happened and as a result an invalid state 2910 is created. From game state 2900, forward tracking (shown by feature 2916) into the front buffer of data frames, key event 2914 shows Hand A 2902 containing two overlapping card hands whereby each of the two card hands has two cards. Key event 2914 is consistent with a split scenario, resolves the split/double-down ambiguity, is valid with respect to game state 2900 and as a result valid game state 2912 is established.

After forward tracking has been done, the data frame that produced the key event that resolved the ambiguity can be established as the current frame 2208 (see FIG. 22). It is to be noted that forward tracking can involve analyzing a plurality of data frames in order to resolve ambiguity.

A particularly useful application of forward tracking can be to minimize the effects of temporary occlusion of gaming objects that can happen during a game as the dealer moves her physical hand across the table, or when there is shaking or vibration of the image of the table. In this alternate application of forward tracking, we can detect if a gaming object has been removed or temporarily occluded by looking in the front buffer of data frames. As an example, assume that a specific card “C” is present at a certain location “X” in a data frame. If the card C is absent at location X from the next data frame, then either card C has been removed from the table, or moved to a different location, or it has been temporarily occluded. We can look into the front buffer of frames to see if card C is present in location X in any of the frames in the front buffer. If card C is present at location X in a front buffer frame, it is very likely that card C is just temporarily occluded and that it has not been moved or removed. Therefore, by performing this analysis, we can insert card C at location X back into the intermediate data frames where card C was missing, thus reducing the chance of ambiguous game states. In this manner, the use of forward buffer can be utilized to mitigate the ambiguity effects of temporary occlusion/disappearance of cards (or other gaming objects) on the gaming table.

Another method that can be used for ambiguity resolution is forward-event waiting. Instead of looking in the front buffer frames for a key event that resolves an ambiguity with respect to the current state, the forward-event waiting method can mark a card hand as being ambiguous and then continue processing the next frame and making game state updates. The ambiguity can be resolved when a specific event relevant to the ambiguous hand is detected at some point in the future. Optionally the ambiguous card hand can have a range within which to look for the specific event that resolves the ambiguity. The range can be a predetermined number of frames, predetermined period of time, or predetermined two events. For example, it can be implemented as a counter that counts the number of frames for which the method “waits” for the ambiguity to be resolved. The counter can have a maximum predetermined number of frames. The range can also be defined by predetermined events such as game start, game end, game play etc. . . . We can look for a relevant key event that resolves the ambiguity within this range. The forward-event waiting method is more suited to card hand ambiguities that can be resolved by game events that can happen much later in the game instead of within a predetermined time window. The forward-event waiting ambiguity resolution can be used together with forward tracking and backward tracking for higher game tracking accuracy.

Tracking “surrendered” hands in Blackjack is an example that is particularly well suited for the forward-event waiting method. In this example the forward-event waiting method with a range of two predetermined game events is utilized. In Blackjack a player has the choice to fold their hand, at the cost of half their original bet. This process is called surrender. Once all players have two cards, and the dealer has one card, the players have an option to surrender their hand. Once there is a game play event (if any player has more than two cards, or has more than one hand due to splits, or the dealer has two or more cards), the player loses the option to surrender. The forward-event waiting ambiguity resolution method can be used to track surrendered hands. Usually when a card hand is missing in the incoming data frame, it could either be removed as the player surrendered her hand, or it could be temporarily occluded by the dealer or some other object. A card hand can sometimes be occluded for a long period of time, for instance when a dealer is speaking to a player and his shirt sleeve is occluding the player's two card hand. In these types of situations, forward tracking may not be effective and consequently forward-event waiting can be used.

In one embodiment of using forward-event waiting to track surrendered hands, the method marks all initial two card hands as ambiguous (the card hands are set to surrender by default) from the start of the game play event (if any player has more than two cards, or has more than one hand due to splits, or the dealer has two or more cards). As new data frames are received, the ambiguity resolution for every hand is simply the detection of the hand in the current data frame. If an ambiguous hand is detected in the current data frame, it is resolved as being ‘not surrendered’. On the event of a game end, all ambiguous hands that weren't detected in the period from the start of the game play event to the game end event, are marked as “surrendered”. Most likely, the hand was not detected because the player surrendered the hand, and it was discarded from the table. Resolving surrendered hands by forward tracking up to a particular data frame may not be as accurate, since a hand could inaccurately be marked as surrender if it was being occluded in the limited set of forward data frames being examined. Therefore, the forward-event waiting based ambiguity resolution is the preferred embodiment to track surrendered hands. In this example the forward-event waiting utilizes a range of two predetermined game events—game play event and game end event.

It is important to note the differences between forward tracking and forward-event waiting for ambiguity resolution. In forward tracking, an attempt is made to resolve the ambiguous card hand (or game state) using game event information from data frames in the front buffer. The next frame is analyzed only after it has been determined if the card hand ambiguity can be resolved or not. In forward-event waiting, the method marks a card hand as ambiguous and continues processing subsequent frames and updating card hands (and game states). The ambiguous card hand is resolved when an appropriate game event is detected in the future to resolve the ambiguity. Forward tracking is well suited for certain types of ambiguities. As an example, forward tracking is well suited to minimize the effects of temporary occlusion of gaming objects. As an example, forward event waiting is well suited for detecting a player hand surrender.

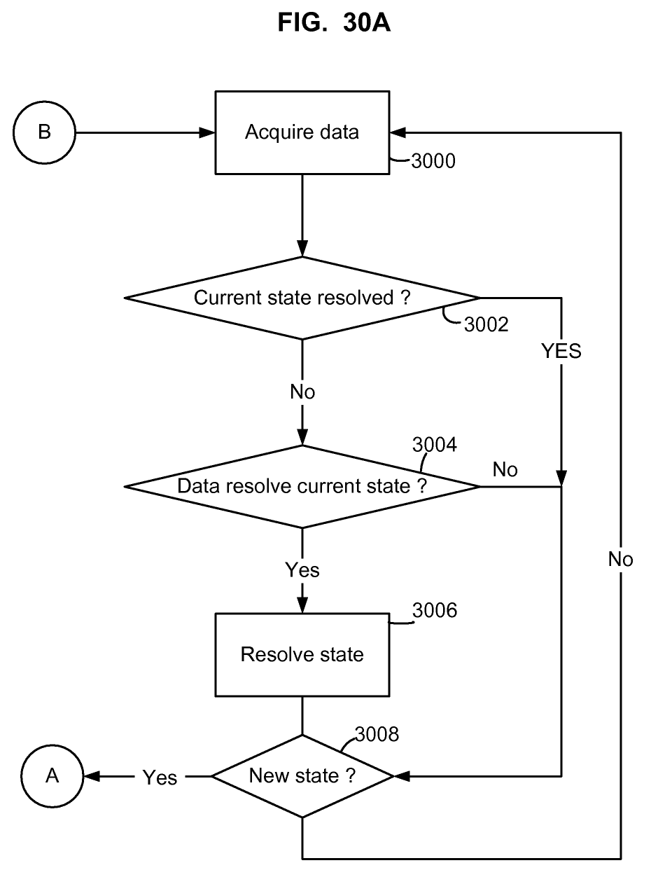

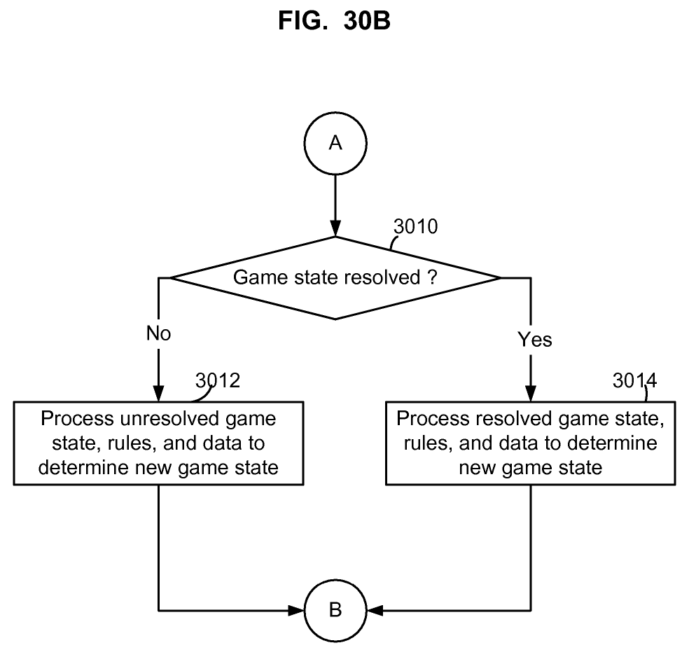

FIGS. 30A and 30B combine to provide a flowchart that describes forward-event waiting.

As mentioned hereinabove, a “game state” is defined by a plurality of game state parameters. For the purposes of the following description, if each of the parameters has a resolved value, the corresponding game state is said to be “resolved”. Otherwise, the corresponding game state is said to be “unresolved”.

In a step 3000, game data is acquired. According to the preferred embodiment of the present invention, the step consists in obtaining information from the IPAT module 84 and IP module 80, and optionally the bet recognition module 88. Subsequently, in a step 3002, it is determined whether a current state of the game is resolved. If the current state is found to be unresolved in the step 3002, it is determined whether the current state of the game is resolvable from a current set of captured data and a set of game rules in accordance to a step 3004. If the current state of the game is found to be resolvable in the step 3004, it is resolved in a step 3006.

If the current state is found to be resolved in the step 3002, or if the current state of the game is not found to be resolvable in the step 3004, it is determined whether a new state of the game is to be established in accordance with a step 3008. If no new state of the game is to be established, the method returns to the step 3000.

However, if it is found that a new state of the game is to be established in the step 3008, it is determined whether the current state of the game is resolved in accordance to a step 3010.

If the current state of the game is found to be resolved in the step 3010, the resolved current state of the game, the data captured in the step 3000, and the rules of the game are processed to create a new current state of the game in accordance to a step 3012. Subsequently, the method returns to the step 3000.

However, if the current state of the game is found to be unresolved in the step 3010, the unresolved state of the game, the data captured in the step 3000, and the rules of the game processed to create a new current state of the game in accordance to a step 3014. Subsequently, the method returns to the step 3000.

As a result, and according to the present invention, the occurrence of an unresolved state does not interrupt the establishment of subsequent game states. Game state parameters are continuously updated and the progress of the game is continuously monitored insofar as possible from the provided data.

According to one embodiment of the present invention, casino personnel may request for a latest, if incomplete, set of game state parameter values to be displayed on a monitor regardless of any occurrence of unresolved game states prior to the request.

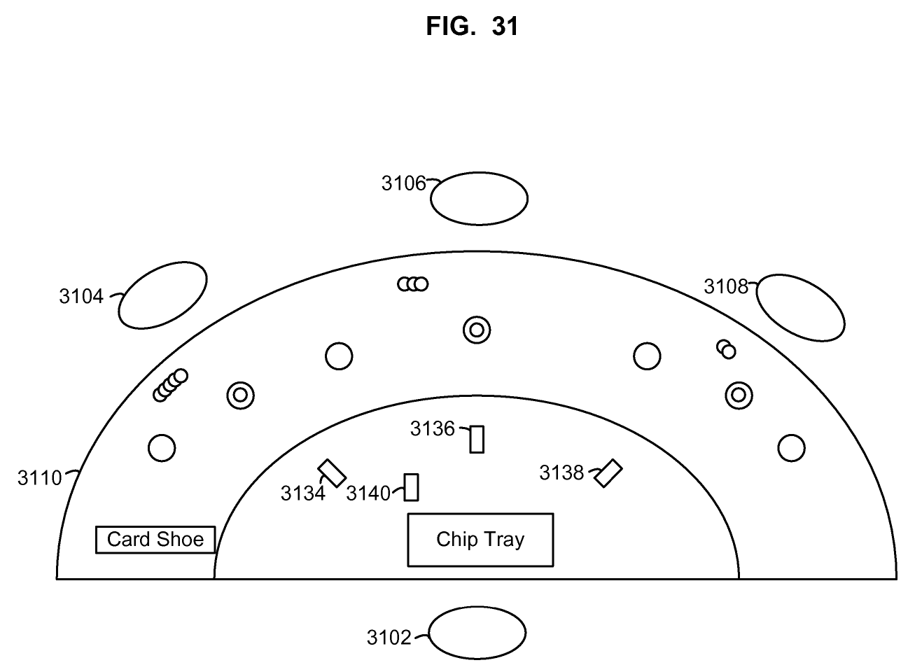

Forward-event waiting will now be described with reference to FIGS. 31, 32, 33, 34, 35, and 36 each of which represents an overhead image of the game table 3110 captured at different times during a game of Black Jack involving a dealer 3102, and three players 3104, 3106, and 3108. Although the invention is typically applied to track a wide variety of game parameters, it will be described within the context of tracking surrendered hands of cards.

FIG. 31 represents an overhead image of the game table 3110 captured early in the game. The players 3104, 3106, and 3108 have card hands 3134, 3136, and 3138 respectively. Each of the card hands 3134, 3136, and 3138 is comprised of one playing card and marked as “Ambiguous Surrender”.

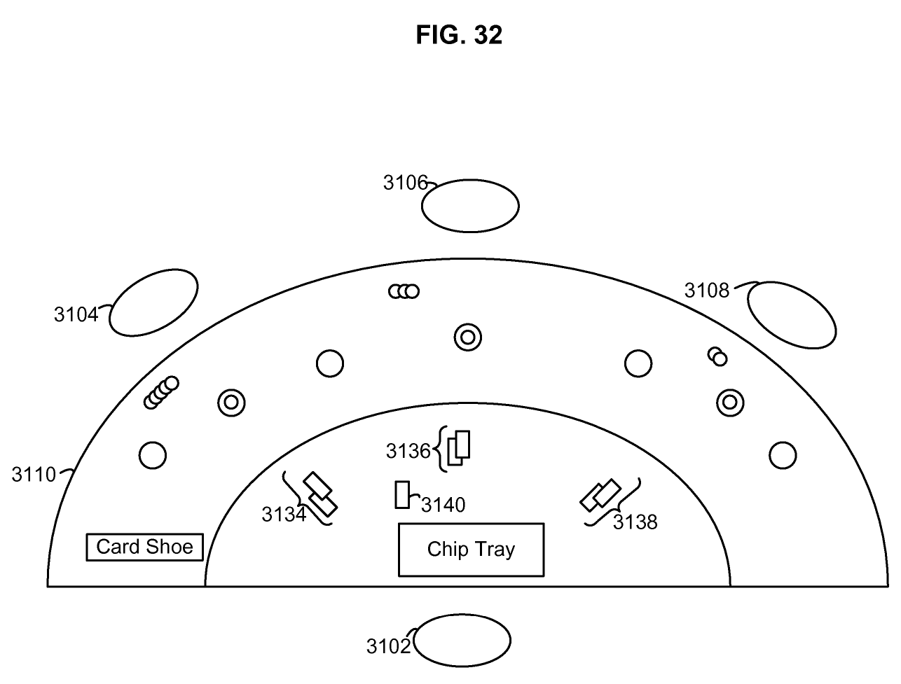

FIG. 32 represents an overhead image of the game table 3110 captured following the one illustrated in FIG. 31. Each of the card hands 3134, 3136, and 3138 is comprised of two cards and marked as “Ambiguous Surrender”.

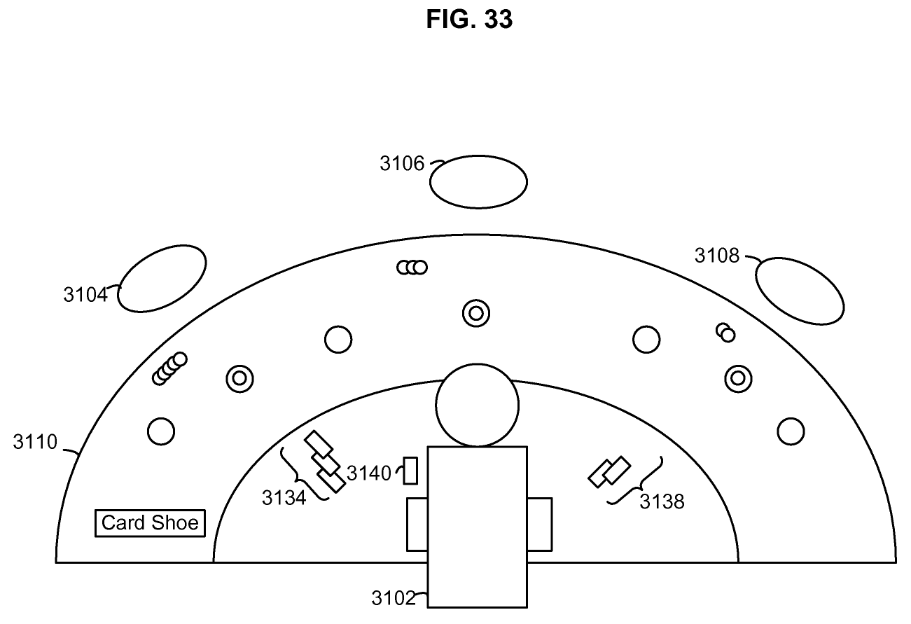

FIG. 33 represents an overhead image of the game table 3110 captured following the one illustrated in FIG. 32. The card hand 3134 is visible and comprised of three playing cards; it is therefore resolved as “Not Surrendered”. The card hand 3138 is visible and comprised of two playing cards; it is therefore resolved as “Not Surrendered”. However, a view of the card hand 3136 is occluded by the dealer 3102; therefore, it remains marked as “Ambiguous Surrender”.

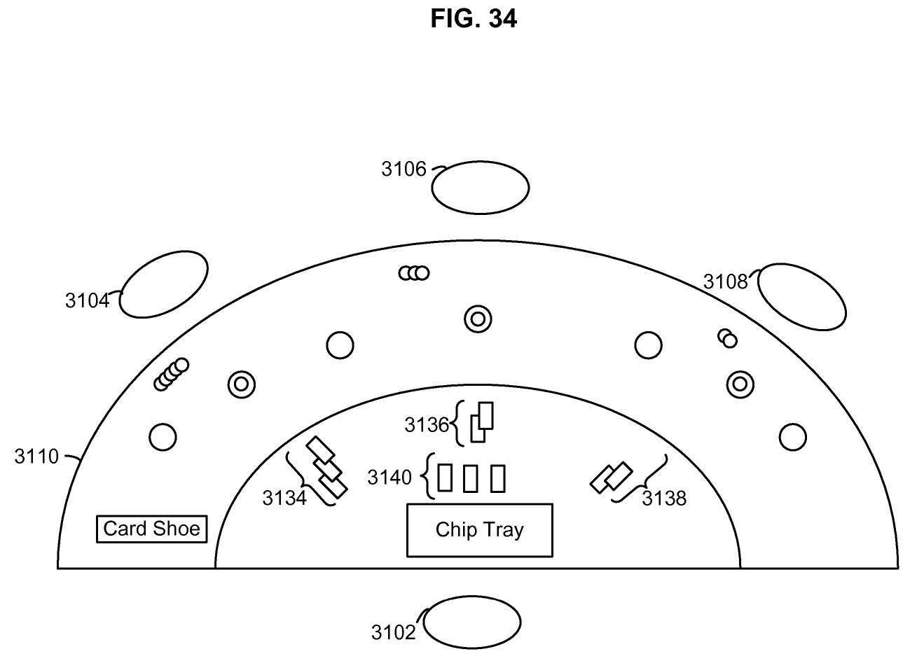

FIG. 34 represents an overhead image of the game table 3110 captured following the one illustrated in FIG. 33. The dealer 3102 is no longer leaning on the table and a view of the card hand 3136 is no longer occluded; the card hand is detected on the game table and therefore, resolved as “Not Surrendered”.

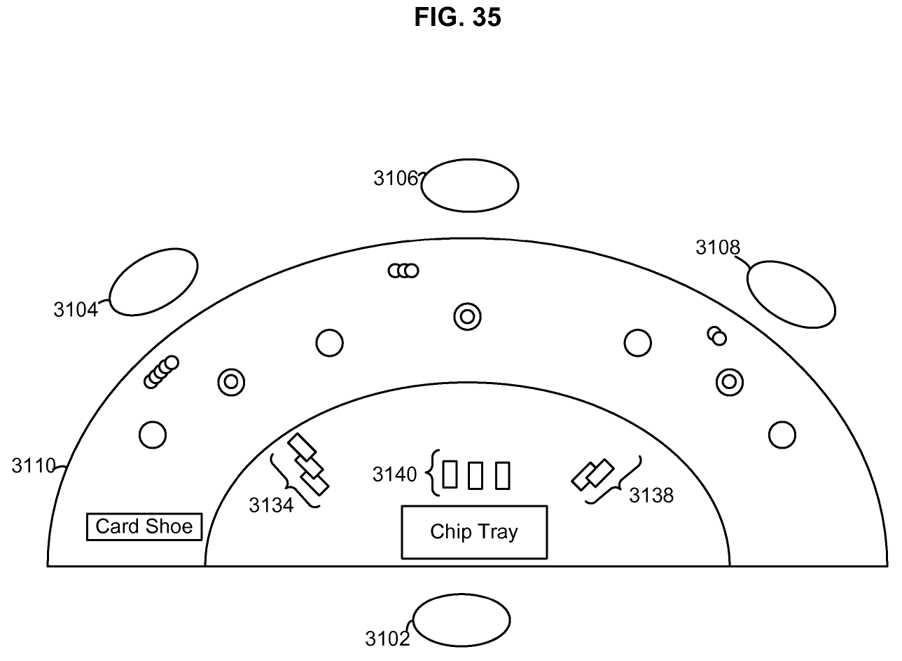

FIG. 35 represents an alternate successor to the image illustrated in FIG. 33. The dealer 3102 is no longer leaning on the table and a view of the card hand 3136 is no longer occluded; however, the card hand 3136 is still not detected on the game table and therefore, it remains marked as “Ambiguous Surrender”.

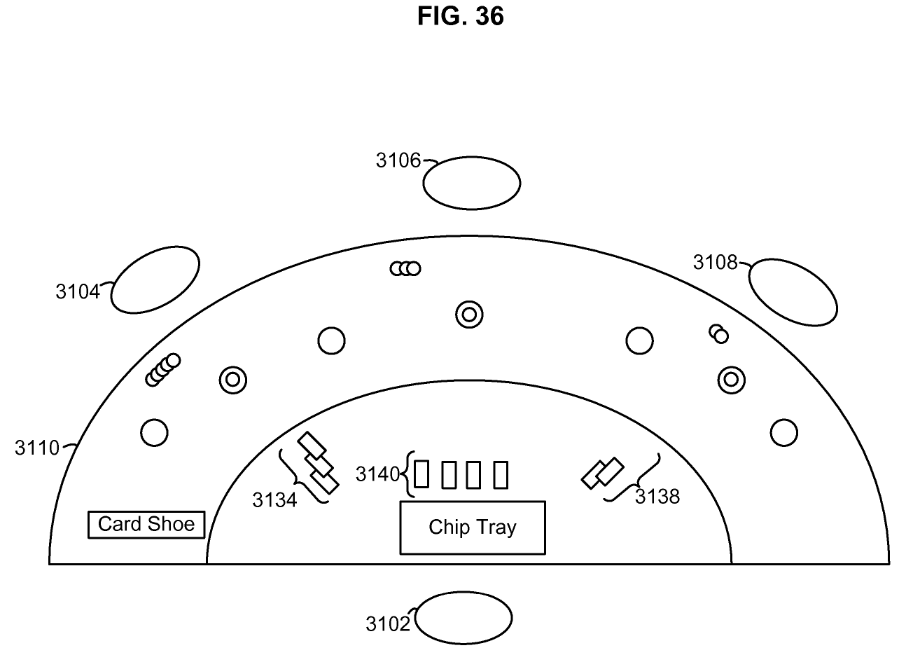

FIG. 36 represents an overhead image of the game table 3110 captured following the one illustrated in FIG. 35. The end of the game is detected, and the card hand 3136 remains undetected; therefore, the card hand 3136 is resolved as “Surrendered”.

Returning to FIG. 7 we will now discuss Bet Recognition Module 88. The Bet Recognition Module 88 can determine the value of wagers placed by players at the gaming table. In one embodiment, an RFID based bet recognition system can be implemented, as shown in FIG. 6. Different embodiments of RFID based bet recognition can be used in conjunction with gaming chips containing RFID transmitters. As an example, the RFID bet recognition system sold by Progressive Gaming International or by Integrated Tracking Systems can be utilized.

In another embodiment, a vision based bet recognition system can be employed in conjunction with the other Modules of this system. There are numerous vision based bet recognition embodiments, such as those described in U.S. Pat. No. 5,782,647 to Fishbine et al.; U.S. Pat. No. 5,183,081 to Fisher et al; U.S. Pat. No. 5,548,110 to Storch et al.; and U.S. Pat. No. 4,814,589 to Storch et al. Commercially available implementations of vision based bet recognition, such as the MP21 system marketed by Bally Gaming or the BRAVO system marketed by Genesis Gaming, may be utilized with the invention.

The Bet Recognition Module 88 can interact with the other Modules to provide more comprehensive game tracking. As an example, the GT Module 86 can send a capture trigger to the Bet Recognition Module 88 at the start of a game to automatically capture bets at a table game.

Referring to FIG. 7 we will now discuss Player Tracking Module 180. The Player Tracking Module 180 can obtain input from the IP Module 80 relating to player identity cards. The Player Tracking Module 180 can also obtain input from the GT Module 86 relating to game events such as the beginning and end of each game. By associating each recognized player identity card with the wager located closest to the card in an overhead image of the gaming region, the wager can be associated with that player identity card. In this manner, comp points can be automatically accumulated to specific player identity cards.

Optionally the system can recognize special player identity cards with machine readable indicia printed or affixed to them (via stickers for example). The machine readable indicia can include matrix codes, barcodes, identity numbers or other identification indicia.

Optionally, biometrics technologies such as face recognition can be utilized to assist with identification of players.

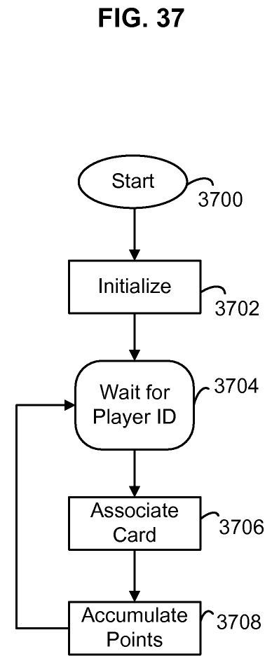

Referring now to FIG. 37 a flowchart of the process of player tracking is shown. The process invoked by the Player Tracking Module 180 starts at step 3700 and moves to step 3702 where the appropriate imaging devices are calibrated and global variables are initialized. At step 3704 processing waits to obtain positioning and identity of a player identity card from IP Module 80. At step 3706 an association is made between a player identity card and the closest active betting region. At step 3708 complementary points are added to the player identity card based upon betting and game activity. Once a game ends processing returns to step 3704.

We will now discuss the functionality of the Surveillance Module 92 illustrated in FIG. 7. The Surveillance Module 92 obtains input relating to automatically detected game events from one or more of the other Modules and associates the game events to specific points in recorded video. The Surveillance Module 92 can include means for recording images or video of a gaming table. The recording means can include the imagers 32. The recording means can be computer or software activated and can be stored in a digital medium such as a computer hard drive. Less preferred recording means such as analog cameras or analog media such as video cassettes may also be utilized.

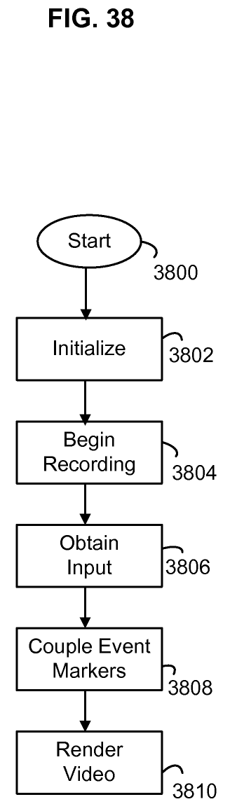

Referring now to FIG. 38 a flowchart of the process of surveillance is shown. Beginning at step 3800 the process starts and at step 3802 the devices used by the Surveillance Module 92 are calibrated and global variables are initialized. Moving to step 3804 recording begins. At step 3806, input is obtained from other Modules. The Surveillance Module 92 can receive automatically detected game events input from one or more of the other Modules. As an example, the Surveillance Module 92 can receive an indicator from the GT Module 86 that a game has just begun or has just ended. As another example, the Surveillance Module 92 can receive input from the Bet Recognition Module 88 that chips have been tampered with. In yet another example, the Surveillance Module 92 can receive input from the Player Tracking Module 180 that a specific player is playing a game. At step 3808 a game event or player data related event is coupled to an event marker on the video. The Surveillance Module 92 associates the game events to specific points in recorded video using digital markers. Various embodiments of markers and associations are possible. As a non-limiting example, the Surveillance Module 92 can keep an index file of game events and the associated time at which they took place and the associated video file that contains the recorded video of that game event. Associating automatically tracked table game events/data to recorded video by using event markers or other markers can provide efficient data organization and retrieval features. In order to assist surveillance operators, data may be rendered onto the digital video. For instance, a color coded small box may be rendered beside each betting spot on the video. The color of the box may be utilized to indicate the current game status for the player. As an example, the color red may be used to indicate that the player has bust and the color green may be used to indicate that the player has won. Various symbols, text, numbers or markings may be rendered onto the surveillance video to indicate game events, alerts or provide data. An advantage of this feature is that it enables surveillance operators to view data faster. For example, it is easier for a surveillance operator to see a green colored box beside a betting spot and understand that the player has won, than to total up the player's cards and the dealer's cards to determine who won. In this feature, game data may be rendered directly onto the video during recording, or the data may be stored in a database and then dynamically rendered onto the video during playback only. Furthermore, additional features such as by example, notes and incident reports can be incorporated into the Surveillance Module 92. Additionally, sound recording may be incorporated into the Surveillance Module 92 in order to capture the sounds happening at the gaming table. For example, sound capturing devices (for example: microphones) may be positioned in the overhead imaging system or lateral imaging system or at any other location in the vicinity of the gaming region. The captured sound may be included into the recorded video. Optionally, speech recognition software or algorithms may be used to interpret the sounds captured at the gaming table. At step 3810 the event data is recorded on video. Processing then returns to step 3806.

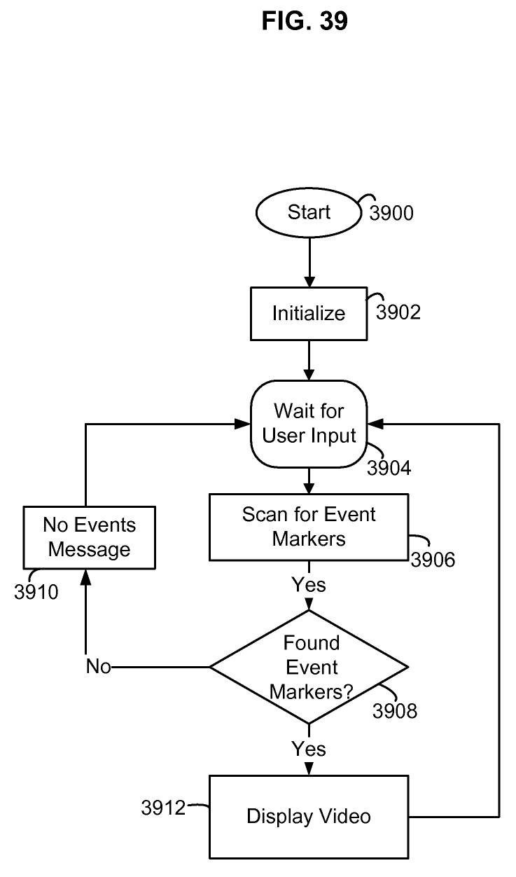

The Surveillance Module 92 can replay certain video sequences relating to gaming events based on a selection of a game event. FIG. 39 is a flowchart of the process of utilizing surveillance data; it illustrates how a user interface may be coupled with the data collected by the Surveillance Module 92 to display data of interest to a user. Processing begins at step 3900 and a step 3902 calibration of the necessary hardware and the initialization of data variables occurs. At step 3904 the process waits for input from the user on what video is requested. The user can select a specific gaming table and view recorded video clips organized by game. Alternatively, the user can select a specific player and view video clips organized by player. Similarly, the user can potentially select certain game events such as tampering of chips and view the clips associated with those game events. At step 3906 a search is made for the event markers that are relevant to the user input of step 3904 and are located on the recorded media. At step 3908 a test is made to determine if any event markers were found. If not processing moves to step 3910 where a message indicating no events were located is displayed to the user. Processing then returns to step 3904. If event markers have been found at step 3908 then processing moves to 3912 and the relevant images are displayed to the user. Control then returns to step 3904 where the user may view the video. During display the user may utilize the standard features of video and sound imaging, for example: speed up, slow down, freeze frame, and increase resolution.

We shall now discuss the Analysis and Reporting Module 94 of FIG. 7. The Analysis and Reporting Module 94 can mine data in the database 182 to provide reports to casino employees. The Analysis and Reporting Module 94 can be configured to perform functions including automated player tracking, including exact handle, duration of play, decisions per hour, player skill level, player proficiency and true house advantage. The Analysis and Reporting Module 94 can be configured to automatically track operational efficiency measures such as hands dealt per hour reports, procedure violations, employee efficiency ranks, actual handle for each table, and actual house advantage for each table. The Analysis and Reporting Module 94 can be configured to provide card counter alerts by examining player playing patterns. It can be configured to automatically detect fraudulent or undesired activities such as shuffle tracking, inconsistent deck penetration by dealers and procedure violations. The Analysis and Reporting Module 94 can be configured to provide any combination or type of statistical data by performing data mining on the recorded data in the database.

Output, including alerts and player compensation notifications, can be through output devices such as monitors, LCD displays, or PDAs. An output device can be of any type and is not limited to visual displays and can include auditory or other sensory means. The software can potentially be configured to generate any type of report with respect to casino operations.

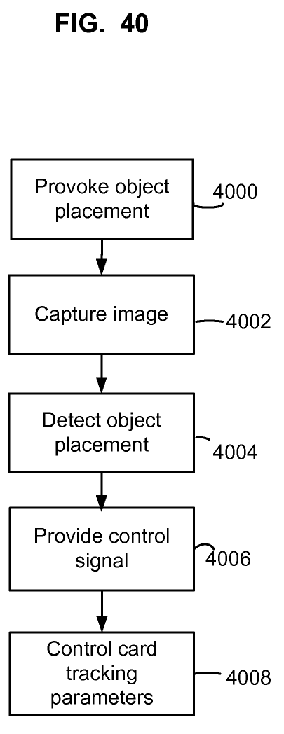

FIG. 40 is a flowchart describing a method according to which the Dealer Tracking Module 95 and the IP Module 80 collaborate to coordinate game monitoring operations according to critical dealing events. When such an event is about to occur, and according to step 4000, the dealer provokes a corresponding, predetermined object placement on the game table. In a step 4002, an overhead camera captures an image of the game table. Subsequently, in a step 4004, the IP Module 80 analyzes the captured image, and recognizes the predetermined object placement. It informs the Dealer Tracking Module 95 which, in a step 4006, provides a control signal to the GT Module 86. In a step 4008 and in response to the provided control signal, the GT Module 86 adjusts its game tracking activities accordingly.

It is important to note that although the step 4000 was described as performed by a dealer, it may very well be performed by an appropriate casino employee or patron.

According to a preferred embodiment of the invention, a predetermined object placement consists in the placement of one of several ID cards on the game table, where each ID card designates a different game event.

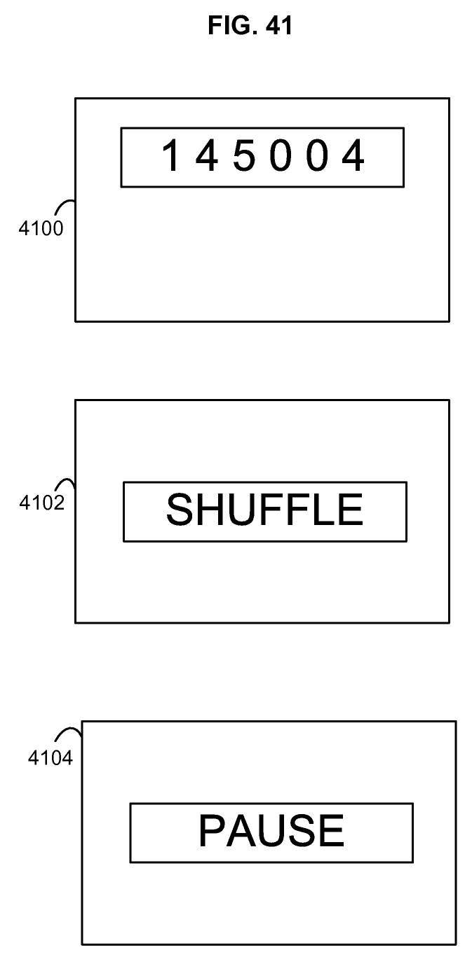

Referring to FIG. 41, and still according to a preferred embodiment of the invention, three different types of ID cards are utilized: a Dealer ID card 4100, a Shuffle card 4102 and a Pause card 4104. Each ID card is endowed with a machine readable code that can be identified by the IP Module 80.

In the illustrated and preferred embodiment, the machine readable code consists in a numeric code. However, according to alternate embodiments of the present invention, other machine readable codes are utilized such as symbolic codes, alphanumeric codes, patterns, bar codes, matrix codes, and color codes. As an example, most cut cards are of solid color and are usually yellow or orange. This solid color can be utilized to recognize the cut card.

It is important to note that different card types can bear different machine readable codes. For instance, according to one exemplary embodiment of the present invention, the Dealer ID card 4100 bears a numeric code, the Shuffle card 4102 consist of a blank cut card that is orange in color, and the Pause card 4104 bears a symbolic code.

The Dealer ID card 4102 serves the purpose of identifying a dealer assigned to a monitored game table. According to a preferred embodiment of the present invention, each dealer is provided with a Dealer ID card bearing a unique, machine readable, numeric code. Prior to performing her first dealing operation on a game table, a dealer places her Dealer ID card on the game table such that the unique, numeric code is visible to an overhead camera. The IP Module 80 identifies and provides the unique numeric code to the Dealer Tracking Module 95 which, in turn, records the provided code in the database 182 such that subsequent tracked games are associated to the identified dealer. After performing her last operation, the dealer removes her Dealer ID card from the table such that subsequently tracked games are associated with a following dealer.

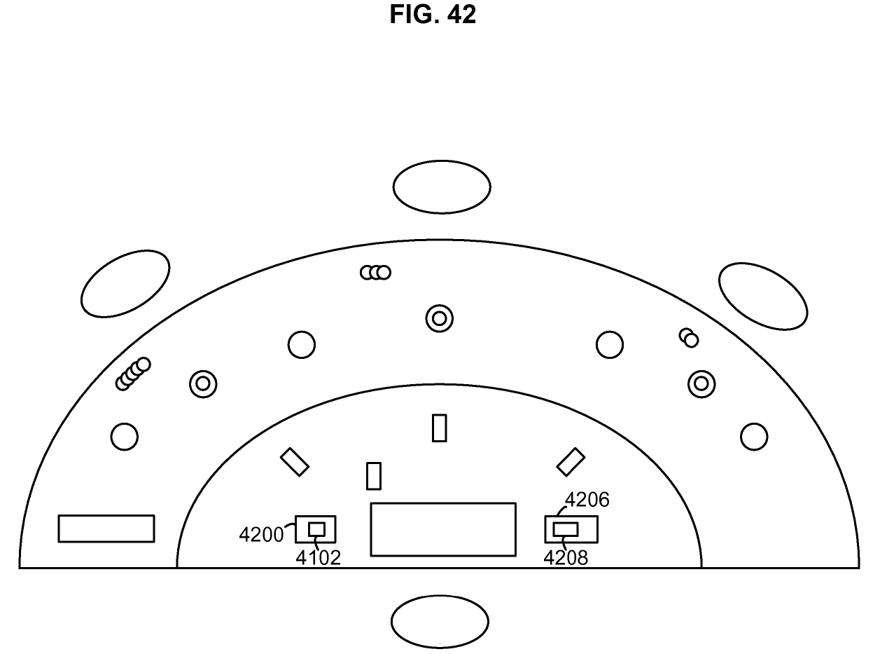

According to one embodiment of the present invention, and referring to FIG. 42, a specific region 4200 on the game table is dedicated to the placement of Dealer ID cards 4202, wherein the detection of such cards 4202 is limited to the specific region 4200, and whereby the detection of such cards 4202 is more efficient. However, according to another embodiment of the present invention, the Dealer ID cards 4202 may be placed anywhere on the game table.

Traditionally, a dealer uses a cut card to demarcate a deck of cards into two sets. As the game progresses, the dealer withdraws cards from the deck until she reaches the cut card, at which point she is required to shuffle the entire deck of cards. Such an event is critical in the process of tracking playing cards as it introduces a new deck of cards to the game table. According to the present invention, when the dealer reaches the cut card, she places the Shuffle card 4102 on the table, such that its machine readable code is visible to the overhead camera. The IP Module 80 identifies and provides the code to the GT Module 86.

According to a preferred embodiment of the present invention, the GT Module 86 marks the next round of games as starting with a new deck of cards and resets the card deck's count and penetration upon receiving the code.

According to another embodiment of the present invention, the GT Module 86 records the occurrence of a card shuffle upon receiving the code.

Once the Shuffle card 4102 is placed on the game table, the dealer may either shuffle the existing deck of cards or discard the deck and introduce a new one to the game table.

According to a preferred embodiment of the invention, the Shuffle card 4102 is used as a cut card. However, according to another embodiment, the Shuffle card 4102 and the cut cards are two distinct cards.

Finally, the Pause card 4104 is used whenever game operations are to be halted. For instance, when a dispute arises at the game table, a pit supervisor may “back up a hand”, a process that consists in removing playing cards from the discard rack and placing them back on the game table. Such an event is critical in the process of tracking playing cards as previously discarded playing cards momentarily recover their positions on the game table. According to the present invention, when a pit supervisor wishes to “back up a hand”, she places the Pause card 4104 on the table such that its machine readable code is visible to the overhead camera. The IP Module 80 identifies and provides the code to the GT Module 86.

According to a preferred embodiment of the present invention, the GT Module 86 suspends game tracking activities upon receiving the code. Once the dispute is resolved, the pit supervisor removes the previously discarded cards from the table, places these cards in the discard rack, and removes the Pause card 4104 from the table.

According to one embodiment of the present invention, the suspension lasts a predetermined amount of time. For instance, it may last 191 seconds from the moment the Pause card 4106 was identified by the IP Module 80. According to another embodiment, the suspension may hold until the Pause Card 4106 is removed from the table. Once the suspension ends, game tracking operations are resumed.

According to yet another embodiment of the present invention, the GT Module 86 records the game interruption in response to receiving the code.

According to one embodiment of the present invention, and in reference to FIG. 42, a specific region 4206 on the game table is dedicated to the placement of Shuffle and Pause cards 4208, wherein the detection of such cards 4208 is limited to the specific region 4206, and whereby the detection of such cards 4208 is more efficient. However, according to another embodiment of the present invention, such cards 4208 may be placed anywhere on the game table.

According to one embodiment of the present invention, the IP Module 80 identifies the Shuffle cards 4102 and the Pause cards 4106 by analyzing overhead images of a gaming region.

According to another embodiment of the present invention, the IP Module 80 identifies the Shuffle cards 4102 by using the card shoe 24, which is capable of reading cut cards as they are dealt on the gaming table 12.

Although not shown in FIG. 7, a Chip Tray Recognition Module may be provided to determine the contents of the dealer's chip bank. In one embodiment an RFID based chip tray recognition system can be implemented. In another embodiment, a vision based chip tray recognition system can be implemented. The Chip Tray Recognition Module can send data relating to the value of chips in the dealer's chip tray to other Modules.

The terms imagers and imaging devices have been used interchangeably in this document. The imagers can have any combination of sensor, lens and/or interface. Possible interfaces include, without limitation, 18/180 Ethernet, Gigabit Ethernet, USB, USB 2, FireWire, Optical Fiber, PAL or NTSC interfaces. For analog interfaces such as NTSC and PAL a processor having a capture card in combination with a frame grabber can be utilized to get digital images or digital video.

The image processing and computer vision algorithms in the software can utilize any type or combination or color spaces or digital file formats. Possible color spaces include, without limitation, RGB, HSL, CMYK, Grayscale and binary color spaces.

The overhead imaging system may be associated with one or more display signs. Display sign(s) can be non-electronic, electronic or digital. A display sign can be an electronic display displaying game related events happening at the table in real time. A display and the housing unit for the overhead imaging devices may be integrated into a large unit. The overhead imaging system may be located on or near the ceiling above the gaming region.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of monitoring the progress of a game on a game table by efficiently establishing game states achieved during said progress, wherein each one of said states is defined by a plurality of state parameters, comprising:
acquiring game data while said game is in progress;
determining values of some of said parameters from at least said data and rules of said game to establish an unresolved state of said game; and
updating values of at least some of said parameters from said data, said rules, and said values defining said unresolved state to establish a subsequent state of said game.

2. The method of claim 1, wherein said acquiring comprises capturing overhead images of said game table, and said determining and updating comprise processing said images as a function of said plurality of parameters.

3. The method of claim 1, further comprising displaying information provided by said subsequent state for monitoring purposes.

4. The method of claim 1, wherein said subsequent state is unresolved, and further comprising resolving said subsequent state from at least said subsequent state and said data.

5. A method of establishing boundaries of a visible portion of one of two overlapping playing cards within an image of a gaming region comprising:
locating positioning features of each of said cards within said image;
establishing a position order of said cards with respect to a reference point according to said features;
determining whether said one playing card is overlapped according to said order and a set of rules for laying said cards;
projecting edges of said one playing card, and those of the other of said cards if said one is overlapped according to results of said determining;
establishing said boundaries according to said edges; and
applying said boundaries for the purpose of recognizing said one playing card.

6. The method of claim 5, wherein said features comprise visible card corner points.

7. The method of claim 5, wherein said applying comprises extracting said visible portion from said image according to said boundaries, and providing said extracted portion for the purpose of limiting recognition activities to said visible portion.

8. The method of claim 5, wherein said applying comprises providing coordinates of said boundaries for the purpose of limiting recognition activities to said visible portion.

9. A method of determining an identity of a partially visible playing card within an overhead image of a gaming region comprising:
delimiting a visible portion of said card within said image;
searching for pips within said portion;
establishing a pip profile according to results of said searching; and
determining said identity according to said profile.

10. The method of claim 9, wherein said playing card comprises at least two pips, and one of said two pips is not within said visible portion, whereby said identity is determined from some of said two pips.

11. The method of claim 9, wherein said searching comprises detecting at least one pip, said establishing comprises determining a position of said pip, and said determining said identity comprises selecting at least one candidate rank according to said position.

12. The method of claim 9, further comprising detecting an index within said portion, and establishing an index profile according to said index, wherein said determining is performed according to said pip profile and said index profile.

13. The method of claim 11, further comprising detecting an index within said portion, and establishing an index profile according to said index, wherein said determining is performed according to said pip profile and said index profile.

14. The method of claim 13, wherein said determining comprises analyzing said index profile, and selecting a rank of said playing card from said at least one candidate rank according to said analysis, and whereby an efficiency and an accuracy of said determining is increased.

15. The method of claim 9, further comprising evaluating a reliability of said identity, and if said identity is not reliable according to results of said evaluating, detecting an index within said portion, establishing an index profile according to said index, and determining said identity according to at least said index profile.

16. The method of claim 9, further comprising delimiting a pip region within said visible portion, wherein said searching is performed exclusively within said region.

17. The method of claim 9, wherein said partially visible card is overlapped by a second playing card, and said delimiting comprises:
locating positioning features of said partially visible card and said second card;
projecting edges of said partially visible card and said second card according to said features;
identifying an area of overlap according to said edges; and
subtracting said overlap area from an area delimited by said edges of said partially visible card to delimit said visible portion.

18. The method of claim 9, wherein said partially visible card is overlapped by a second playing card, and said delimiting comprises:
locating positioning features of said partially visible card and said second card;
establishing a position order of said partially visible card and said second card with respect to a reference point according to said features;
determining whether said partially visible card is overlapped according to said order and a set of rules for laying said partially visible card and said second card;
projecting edges of said partially visible card, and those of said second card if said partially visible card is overlapped according to results of said determining; and
detecting boundaries of said portion according to said edges.

19. A method of generating a control signal on a game table comprising:
provoking a predetermined object placement on said table;
capturing an overhead image of said placement;
detecting said placement within said image; and
providing a control signal in response to said detecting for monitoring purposes.

20. The method of claim 19, wherein said object is associated with an identity of a dealer assigned to said game table, and said control signal comprises said identity.

21. The method of claim 19, further comprising delimiting a region of said table dedicated to said placement, wherein said provoking and said detecting are performed within said region.

22. The method of claim 19, wherein said object is a cut card, and said control signal indicates a card deck shuffle.

23. The method of claim 19, wherein said control signal indicates a temporary suspension of a game on said table.

24. The method of claim 23, further comprising suspending card tracking activities in response to said signal.

25. The method of claim 22, further comprising resetting card tracking parameter values in response to said providing.

26. A method of managing parameters for tracking playing cards dealt from a card deck on a game table comprising:
placing a cut card within said deck;
dealing some playing cards of said deck on said table;
recognizing said cards as they are dealt on said table;
recording card tracking parameter values as said cards are recognized;
dealing said cut card;
recognizing said cut card as it is dealt on said table;
resetting said values in response to said recognizing said cut card; and
shuffling said deck in response to said recognizing said cut card, whereby said values are seamlessly recorded and reset according to game procedures for the purpose of determining game statistics.

27. The method of claim 26, wherein said recognizing said cards comprise capturing overhead images of said table, analyzing said images, and recognizing said cards within said images according to results of said analyzing.

28. The method of claim 27, wherein said recognizing said cut card comprises capturing overhead images of said table, analyzing said images, and recognizing said cut card within at least one of said images according to results of said analyzing.
